(19) United States
(12) Patent Application Publication
(10) Pub. No.: US 2026/0140818 A1
(43) Pub. Date: May 21, 2026

(54) DETECTING ERRORS IN A DATA BLOCK USING MULTIPLE CODEWORDS

(71) Applicant: Micron Technology, Inc., Boise, ID (US)

(72) Inventors: Marco SFORZIN, Cernusco Sul Naviglio (IT); Paolo AMATO, Treviglio (IT); Christophe Vincent Antoine LAURENT, Agrate Brianza (IT); Ferdinando BEDESCHI, Biassono (IT); Luca BARLETTA, Milano (IT); Antonino FAVANO, Milano (IT); Marco Pietro FERRARI, Milano (IT)

(21) Appl. No.: 19/338,326

(22) Filed: Sep. 24, 2025

Related U.S. Application Data
(60) Provisional application No. 63/722,943, filed on Nov. 20, 2024.

(51) Int. Cl. G06F 11/10

(52) U.S. Cl. CPC G06F 11/10

(57) ABSTRACT

In some implementations, a memory system controller may receive a data block that is associated with a first codeword having a first data portion and a first parity portion, and a second codeword having a second data portion, a second parity portion, and a metadata portion. The memory system controller may detect and correct one or more errors at one or more symbol locations in the first codeword using information in the first codeword. The memory system controller may set one or more erasure conditions at one or more symbol locations in the second codeword that share a positional relationship with the one or more symbol locations in the first codeword having the one or more errors. The memory system controller may correct the one or more erasure conditions at the one or more symbol locations in the second codeword using information in the second codeword.

### CROSS-REFERENCE TO RELATED APPLICATION

This Patent Application claims priority to U.S. Provisional Patent Application No. 63/722,943, filed on Nov. 20, 2024, entitled “DETECTING ERRORS IN A DATA BLOCK USING MULTIPLE CODEWORDS,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to detecting errors in a data block using multiple codewords.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL) protocol and/or a CXL compliant memory system.

### BRIEF DESCRIPTION OF THE DRAWINGS

FIG. 1 is a diagram illustrating an example system capable of detecting errors in a data block using multiple codewords.

FIG. 2 is a diagram illustrating another example system capable of detecting errors in a data block using multiple codewords.

FIGS. 3A-3H are diagrams of examples associated with detecting errors in a data block using multiple codewords.

FIGS. 4A-4C are diagrams of other examples of detecting errors in a data block using multiple codewords.

FIGS. 5A-5D are diagrams of other examples of detecting errors in a data block using multiple codewords.

FIG. 6 is a flowchart of an example method associated with detecting errors in a data block using multiple codewords.

### DETAILED DESCRIPTION

Robust data integrity is important in modern computing systems, particularly as memory devices like dynamic random access memories (DRAMs) become increasingly dense and integrated within complex architectures such as compute express link (CXL) platforms. In some examples, maintaining data integrity may include incorporating an ability to correct errors that may occur during data storage and retrieval processes. For example, a traditional approach to error correction involves the use of error-correcting codes (ECC), which can detect and correct various error patterns, including single-bit or multi-bit errors.

In some examples, an ECC may be capable of detecting and/or correcting multiple errors associated with an entire memory chip or die failing, which is sometimes referred to as “chipkill” protection. Such chipkill protection schemes may rely on a full capacity of parity dies associated with the memory system to provide the chipkill protection capability. However, in certain memory applications, metadata may need to be stored in the parity dies and/or transmitted alongside user data. In such examples, the metadata may need to be protected against errors and/or may need to be stored and/or transmitted without significantly impacting the memory system's error correction capabilities. Accordingly, traditional chipkill protection schemes may be unavailable in such memory systems, resulting in reduced error correction capabilities, loss of data, and/or increased power, computing, storage, and other resource consumption associated with detecting and correcting errors in memory systems.

Some techniques and implementations described herein enable memory systems capable of delivering robust error detection and correction capability, particularly memory systems that may be enabled to mitigate the impact of chipkill events and/or that may preserve the integrity of metadata, while minimizing increases in system complexity. In some implementations, a memory system may process a data block received from multiple memory devices, with the data block being associated with a first codeword comprising a first data portion and associated parity, and a second codeword comprising a second data portion, a second parity portion, and a metadata portion. The memory system may be configured to detect and rectify errors in the first codeword, and to determine and correct erasures in the second codeword by leveraging the relationship between the positions of the first codeword errors and the second codeword.

Additionally, or alternatively, some techniques and implementations described herein enable application of advanced coding schemes such as Reed-Solomon (RS) codes or non-binary Hamming (NBH) codes tailored to specific symbol-device ratio requirements, and/or adoption of error correction strategies oriented toward chipkill or specific data-pin (sometime referred to as “DQ” pins) location error scenarios (e.g., DQ error scenarios). Additionally, the techniques and implementations described herein may enhance error pattern handling capability using on-die single error correction (OD-SEC) data and cyclic redundancy check (CRC) mechanisms for more effective error detection within the second codeword.

In this way, the techniques and implementations described herein may meet the demanding error correction specifications necessitated by contemporary high-density and high-performance memory frameworks. This sophisticated error-correction technology may thus improve reliability and ensure data integrity, particularly when metadata is to be preserved and/or transmitted alongside user data. The techniques and implementations described herein may enable curtailing of the potential for catastrophic data loss due to chipkill events. In some implementations, chipkill protection may be achieved while upholding operational efficacy and constraining the addition of system complications. Moreover, by improving the quality and/or the reliability of the memory system, the amount of resources used to support computing environments that utilize such memory systems (e.g., raw materials, manufacturing tools, labor, and computing resources) may be reduced, contributing to a sustainable technology ecosystem.

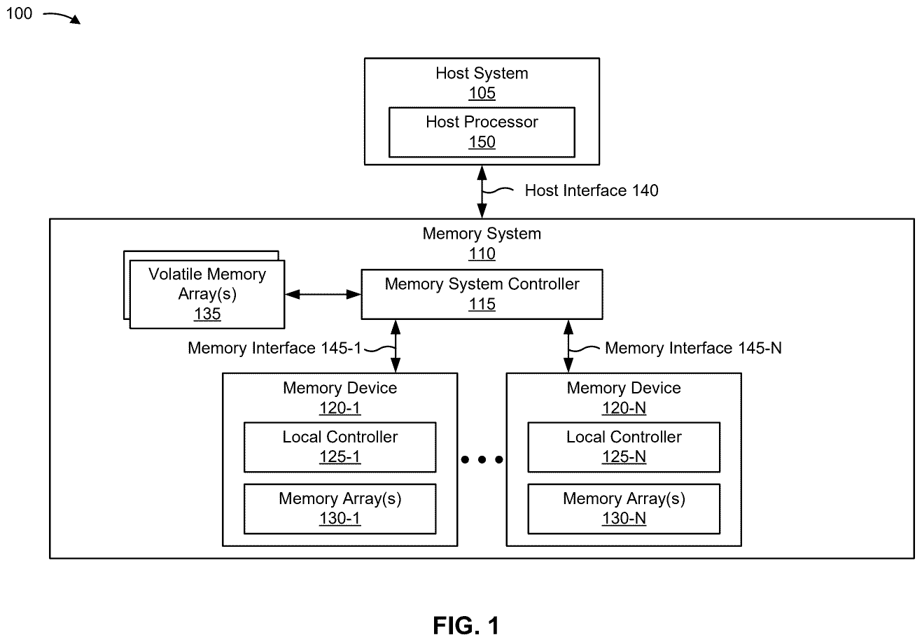

FIG. 1 is a diagram illustrating an example system 100 capable of detecting errors in a data block using multiple codewords. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a CPU, a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

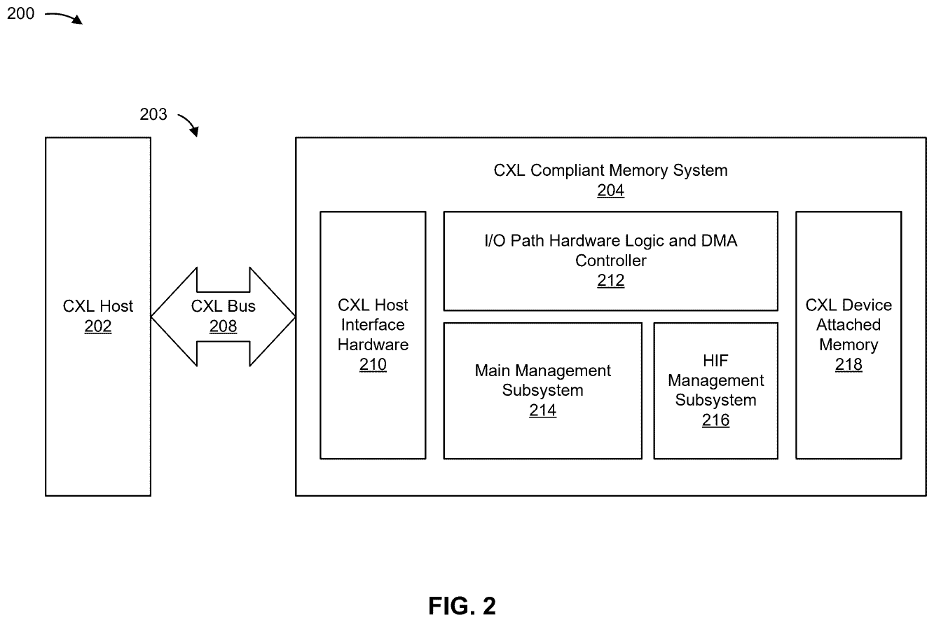

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from multiple memory devices associated with a memory system, a data block, wherein the data block is associated with: a first codeword associated with a first data portion and a first parity portion, and a second codeword associated with a second data portion, a second parity portion, and a metadata portion; detect one or more errors at one or more symbol locations in the first codeword; correct the one or more errors in the first codeword using information in the first codeword; set one or more erasure conditions at one or more symbol locations in the second codeword, wherein the one or more symbol locations in the second codeword share a positional relationship with the one or more symbol locations in the first codeword having the one or more errors; and correct the one or more erasure conditions at the one or more symbol locations in the second codeword using information in the second codeword.

In some implementations, one or more systems, devices, apparatuses, components, and/or controllers of FIG. 1 may associated with a memory system including multiple memory devices; and a host system in communication with the memory system, wherein the host system includes one or more components configured to: receive, from the memory system, a data block, wherein the data block is associated with: a first codeword associated with a first data portion and a first parity portion, and a second codeword associated with a second data portion, a second parity portion, and a metadata portion; detect one or more errors at one or more symbol locations in the first codeword; correct the one or more errors in the first codeword using information in the first codeword; set one or more erasure conditions at one or more symbol locations in the second codeword, wherein the one or more symbol locations in the second codeword share a positional relationship with the one or more symbol locations in the first codeword having the one or more errors; and correct the one or more erasure conditions at the one or more symbol locations in the second codeword using information in the second codeword.

In some implementations, one or more systems, devices, apparatuses, components, and/or controllers of FIG. 1 may be configured to receive, from multiple DRAM dies associated with a CXL compliant memory system, a data block, wherein the data block is associated with: a first codeword associated with a first data portion and a first parity portion, and a second codeword associated with a second data portion, a second parity portion, and a metadata portion; detect one or more errors at one or more symbol locations in the first codeword; correct the one or more errors in the first codeword using information in the first codeword; set one or more erasure conditions at one or more symbol locations in the second codeword, wherein the one or more symbol locations in the second codeword share a positional relationship with the one or more symbol locations in the first codeword having the one or more errors; and correct the one or more erasure conditions at the one or more symbol locations in the second codeword using information in the second codeword.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 capable of detecting errors in a data block using multiple codewords. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL. io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

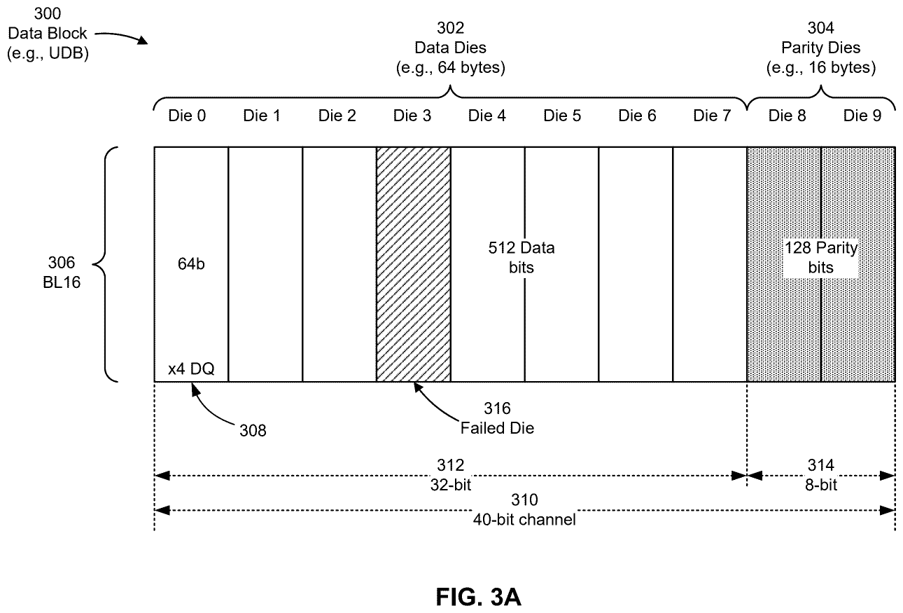

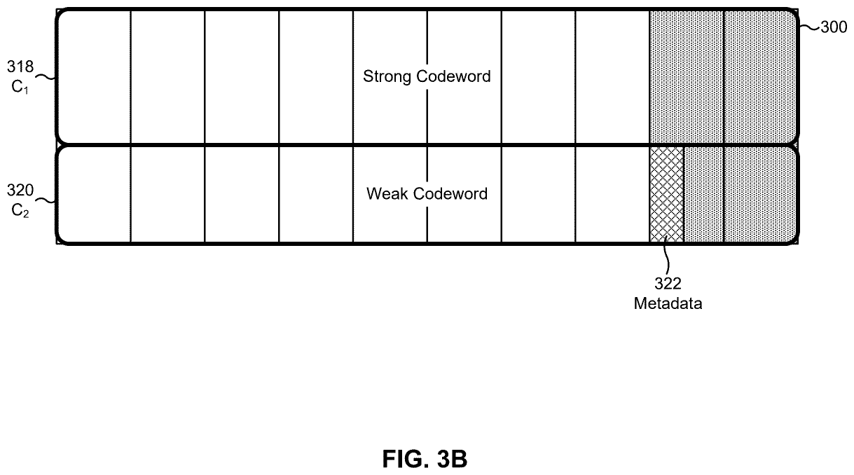

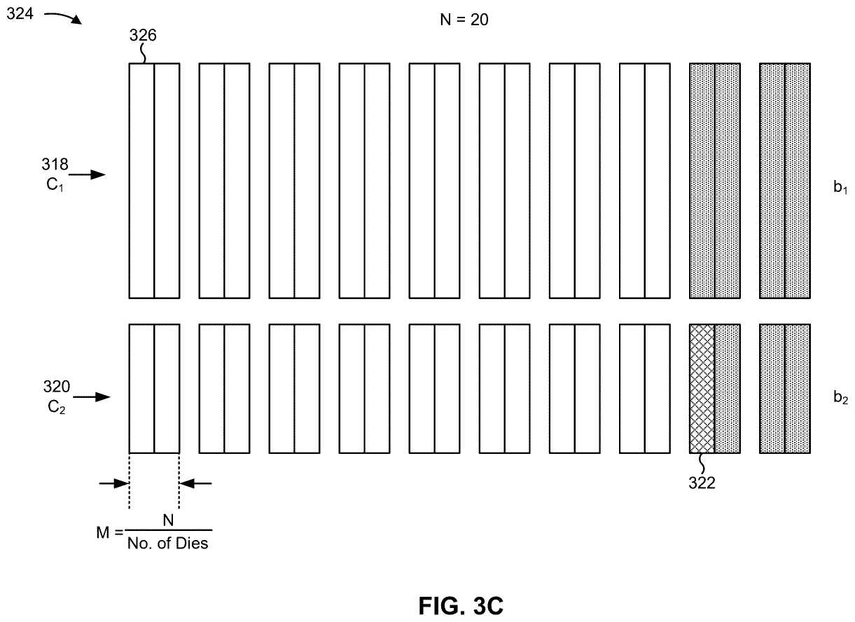

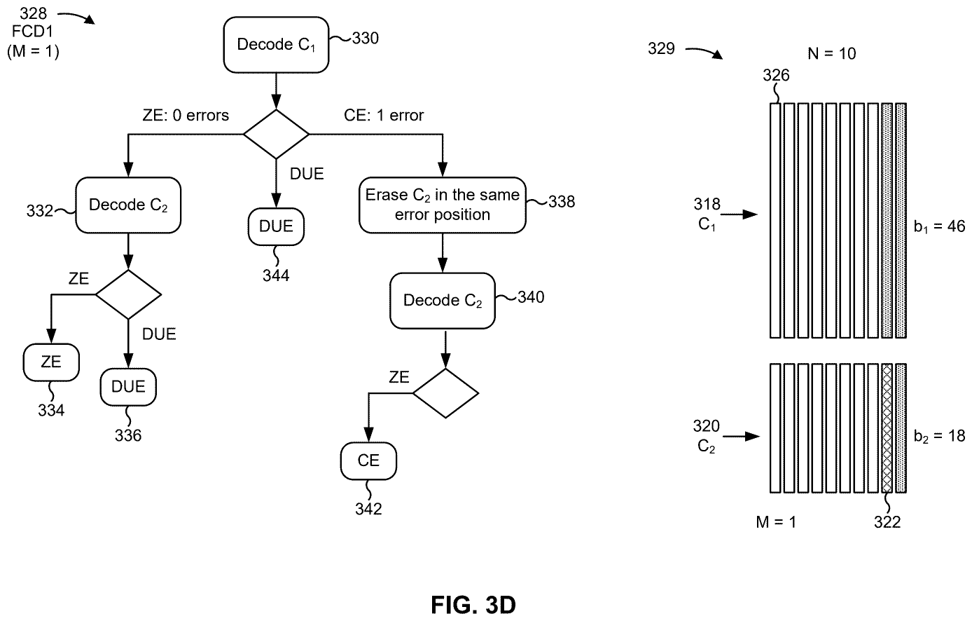

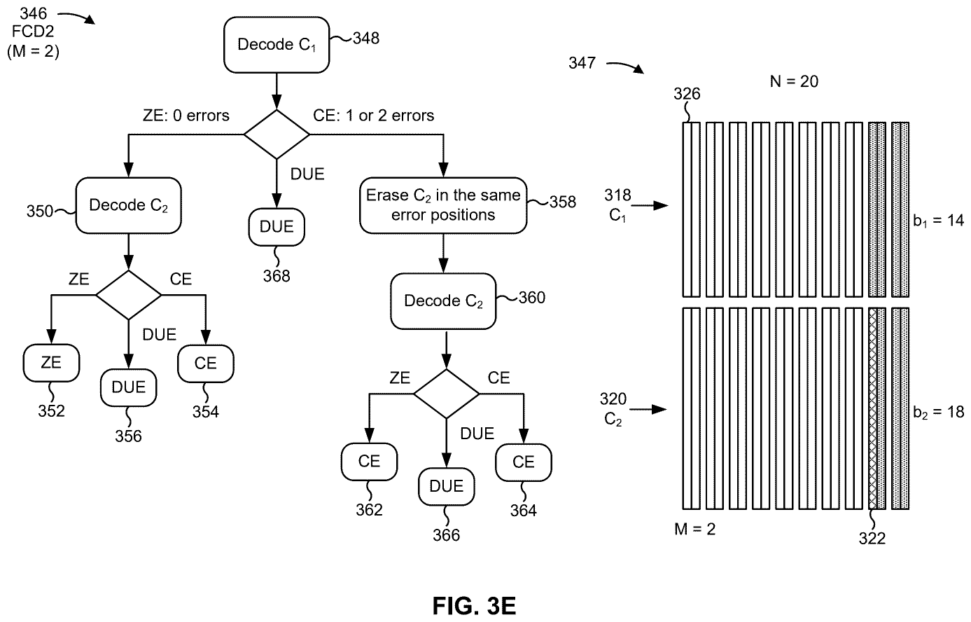

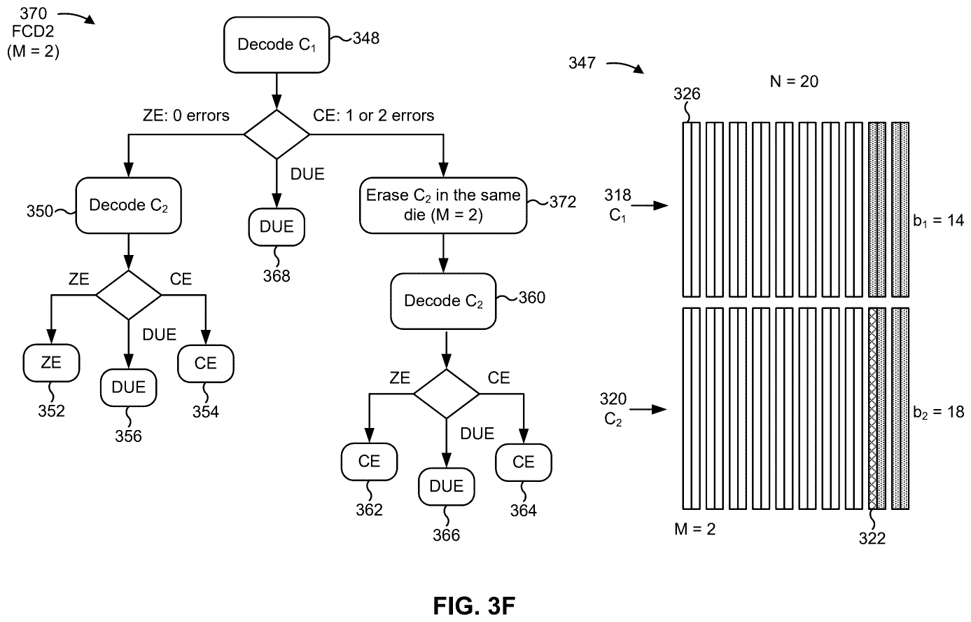

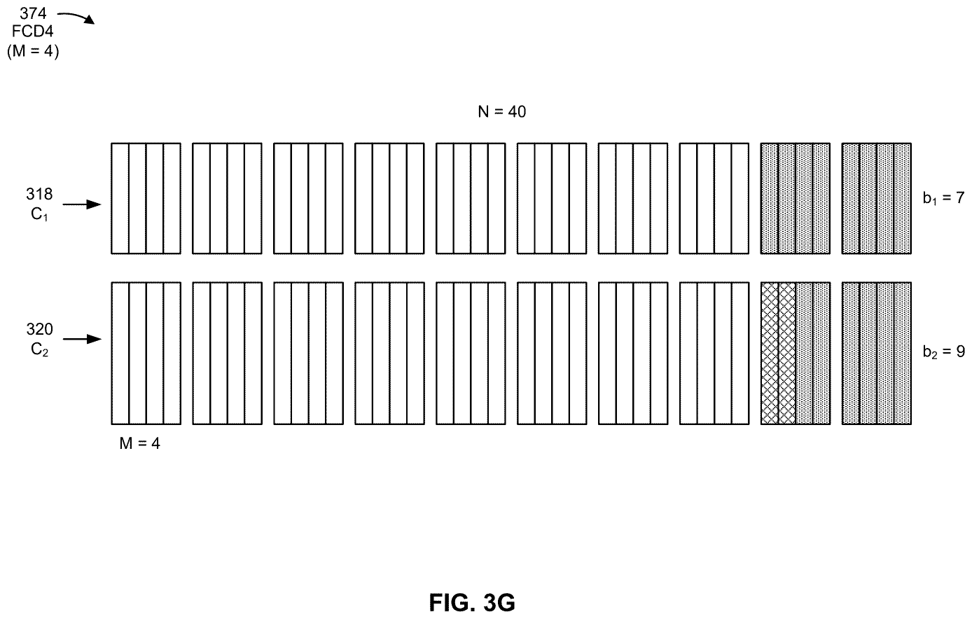

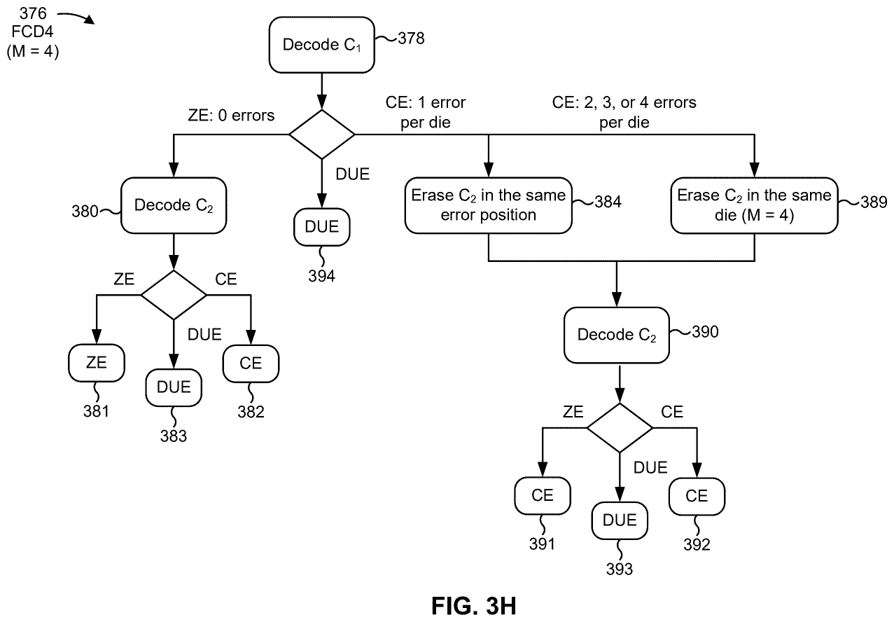

FIGS. 3A-3H are diagrams of examples associated with detecting errors in a data block using multiple codewords. The operations described in connection with FIGS. 3A-3H may be performed by the memory system 110 and/or one or more components of the memory system 110, such as the memory system controller 115, one or more memory devices 120, and/or one or more local controllers 125; the host system 105 and/or one or more components of the host system 105, such as the host processor 150; the CXL compliant memory system 204 and/or one or more components of the CXL compliant memory system 204 (e.g., a CXL ASIC), such as the main management subsystem 214, the CXL device attached memory 218, and/or one or more components of the CXL device attached memory 218; and/or the CXL host 202 and/or one or more components of the CXL host 202.

As shown in FIG. 3A, an ECC may be used in connection with a data block 300 (sometimes referred to as a memory frame, a data frame, a user data block (UDB), and/or a similar term). In some examples, the data block 300 may be associated with a memory channel (e.g., a data pathway between memory and other components of a memory device, such as a memory controller and/or a processor), with a “width” of the memory channel (e.g., measured in bits) referring to a quantity of bits that may be transferred in one operation and/or one memory cycle. For example, as described in more detail below, in some examples the data block 300 may be associated with a 40-bit channel, and thus a memory system associated with the data block 300 may be referred to as a 40-bit memory system. For example, the memory system may be a double data rate 5 (DDR5) 40-bit memory system, or a similar device.

The data block 300 may be associated with multiple dies of memory (e.g., multiple memory devices, which may correspond to the memory devices 120 and/or the CXL device attached memory 218, among other examples) used to store data bits and/or parity bits. Put another way, in some examples multiple data bits and/or parity bits associated with the data block 300 may be stored across multiple dies (e.g., multiple DRAM components and/or chips). For example, the data block 300 shown in FIG. 3A is associated with ten dies (e.g., ten DRAM components and/or chips), indexed as Die 0 through Die 9, with Dies 0-7 used to store data bits (and thus referred to as data dies, as indicated by reference number 302) and with Dies 8-9 used to store parity bits for error correction purposes (and thus referred to as parity dies, as indicated by reference number 304). As indicated by reference number 306, the data block 300 may be associated with a burst length of 16 (sometimes referred to herein as “BL 16”) and/or, as indicated by reference number 308, each die may be configured in a “by four” (sometimes referred to herein as “x4”) configuration, such that each die includes four input/output pins (sometimes referred to as DQ pins). In this regard, the portion of each die associated with the data block 300 may be capable of storing 64 bits (e.g., 8 bytes). In some examples, the data block 300 may be associated with 64 bytes of data (corresponding to the portions of the eight data dies indicated by reference number 302, each capable of storing 8 bytes) and 16 bytes of parity information (corresponding to the portions of the two parity dies indicated by reference number 304, each capable of storing 8 bytes). Put another way, the portions of the data dies associated with the data block 300 may collectively store 512 data bits and/or the portions of the parity dies associated with the data block 300 may collectively store 128 parity bits, with each of the 128 parity bits being a function of the 512 data bits. In this way, a BL16 access to 64 bytes of data may include ten dies in x4 mode, with eight dies providing the 64 bytes of data (e.g., 8 bytes per die) and with two dies providing the 16 bytes of redundancy (e.g., 8 bytes per die) for error correction purposes.

Moreover, as indicated by reference number 310, the data block 300 may be associated with a 40-bit channel, of which 32 bits may be associated with data bits (as indicated by reference number 312) and 8 bits may be associated with parity bits (as indicated by reference number 314). In some examples, a memory system (e.g., memory system 110 and/or CXL compliant memory system 204) may be organized into channels and/or ranks. For example, a memory system may include four ranks and/or 4×40-bit channels. In that regard, the data block 300 shown in FIG. 3A may be associated with data provided by an access in a certain rank of a certain channel.

In some examples, the parity dies may store information that may be used in connection with an ECC to correct data, such as in an event in which an entire die fails (e.g., sometimes referred to as “chipkill” protection). Put another way, an error correction system associated with the data block 300 may be able to correct errors due to an entire die failure. For example, as indicated by reference number 316, in some events an entire die of a DRAM stack may fail (e.g., in the depicted example, Die 3 fails). In such cases, the parity bits stored in the parity dies may be encoded in such a way that the remaining data bits (e.g., the data bits stored at Dies 0-2 and 4-7) and the parity bits (e.g., the parity bits stored at Dies 8-9) may be used to recover data that is stored on the failed die (e.g., Die 3).

For example, a chipkill protection scheme may be obtained by using an RS code with 8-bit symbols (with the size of each symbol sometimes referred to as m). In such cases, a size of a symbol set (sometimes referred to as q) used in the RS coding scheme for the 40-bit data block 300 may be equal to 256 (e.g., 2^{m}=2⁸), a length of an RS codeword (sometimes referred to as N) may be 80 symbols, and a length of the data portion of the RS codeword (sometimes referred to as K and/or the payload of the codeword) may be 64 symbols. In some examples, RS codes may be capable of correcting up to t symbols, with t being equal to (N-K)/2. Thus, for the 8-bit symbol example described above, the RS code may be capable of correcting up to (80-64)/2=8 symbols (e.g., 8 bytes), which is equivalent to an amount of data stored on one die of the data block 300. In this regard, the 8-bit RS code may be used to provide chipkill protection in an event in which an entire die of the data block 300 fails.

In some other examples, a chipkill protection scheme may be alternatively obtained by using an RS code with 16-bit symbols (e.g., m=16). In such cases, a size of a symbol set (e.g., q) used in the RS coding scheme for the 40-bit data block 300 may be equal to 65,536 (e.g., 2¹⁶), a length of each RS codeword (e.g., N) may be 40 symbols, and a length of the data portion of the RS codeword (e.g., K) may be 32 symbols. Thus, the 16-bit symbol example may be capable of correcting up to 4 symbols (e.g., t=(N-K)/2=(40-32)/2=4 symbols, or 8 bytes), which is equivalent to an amount of data stored on one die associated with the data block 300. In this regard, the 16-bit RS code may also be used to provide chipkill protection in an event in which an entire die of the data block 300 fails.

In some other examples, a chipkill protection scheme may be alternatively obtained by using two RS codes with 8-bit symbols (e.g., m=8). In such cases, a size of a symbol set (e.g., q) used in the RS coding scheme for the 40-bit data block 300 may be equal to 256 (e.g., 2⁸), a length of each RS codeword (e.g., N) may be 40 symbols, and a length of the data portion of each RS codeword (e.g., K) may be 32 symbols. Thus, each codeword in the two 8-bit-symbol RS codeword example may be capable of correcting up to 4 symbols (e.g., t=(N-K)/2=(40-32)/2=4 symbols, or 4 bytes), and thus collectively the two RS codewords may be capable of correcting up to 8 bytes, which is equivalent to an amount of data stored on one die associated with the data block 300. In this regard, the two RS codes with 8-bit symbols may also be used to provide chipkill protection in an event in which an entire die of the data block 300 fails.

In this way, certain ECC procedures (e.g., ECC procedures implementing RS codes, such as the procedures described above) may not be capable of conveying metadata via a codeword associated with the ECC. For example, returning to the RS-based chipkill procedures described above, all parity bits may be necessary in order to provide chipkill protection, and thus no portion of the parity dies may be available for storing metadata. Thus, in memory operations in which metadata is to be transmitted via a channel (e.g., the 40-bit channel), such as up to 18 bits of metadata associated with the data block 300, the above-described chipkill error protection schemes may be unusable.

Some implementations described herein enable ECC procedures that provide chipkill protection while enabling metadata to be stored with a data block and/or transmitted with a codeword. For example, some implementations described herein enable ECC procedures that may provide chipkill protection for a 64-byte data block (e.g., data block 300) while enabling up to 18 metadata bits to be stored with the data block and/or transmitted via a corresponding codeword. More particularly, as shown in FIG. 3B, in some implementations the data block 300 may be partitioned into two codewords, including a first codeword 318 (sometimes referred to herein as “C₁” and/or a “strong codeword”) and a second codeword 320 (sometimes referred to herein as “C₂” and/or a “weak codeword”). As described in more detail below, in some implementations the first codeword 318 and the second codeword 320 may be associated with RS codes. However, in some other implementations, the first codeword 318 and the second codeword 320 may be associated with other coding schemes, such as NBH codes, among other examples. In some implementations, the second codeword 320 may store metadata 322, such as up to 18 bits of metadata, among other examples. In such implementations, a portion of the parity dies (e.g., the parity dies described above in connection with reference number 304) that are associated with the second codeword 320 (e.g., the weak codeword) may be used to store the metadata 322, as shown in FIG. 3B.

In such implementations, error detection and correction capabilities of the first codeword 318 (e.g., the strong codeword) may be used to assist error detection and/or correction at the second codeword 320 (e.g., the weak codeword). In some examples, associating a data block (e.g., data block 300) with two codewords (e.g., the first codeword 318 and the second codeword 320) and using error detection and correction capabilities of the strong codeword to assist error detection and/or correction at the weak codeword may be referred to herein as fast collaborative decoding (FCD).

In some implementations, FCD may be associated with a parameter, M, that corresponds to a total quantity of symbols associated with each codeword (e.g., N) divided by a quantity of dies associated with the data block 300 (e.g., 10 in the example described above in connection with FIG. 3A). More particularly, FIG. 3C shows a symbol configuration 324 associated with one example of an FCD scheme, such as an FCD scheme implementing RS codes and/or RS codewords. As shown in FIG. 3C, each codeword 318, 320 may be associated with a quantity of symbols 326 (e.g., N symbols 326) of an RS code. For example, in the symbol configuration 324 shown in FIG. 3C, each codeword 318, 320 is associated with 20 symbols 326 (e.g., N=20), and thus M=20 divided by the total number of dies, which is 10 dies in this example. Put another way, in the symbol configuration 324, M=2 because each codeword is associated with 20 symbols and the data block 300 is associated with 10 dies (as described above in connection with FIG. 3A).

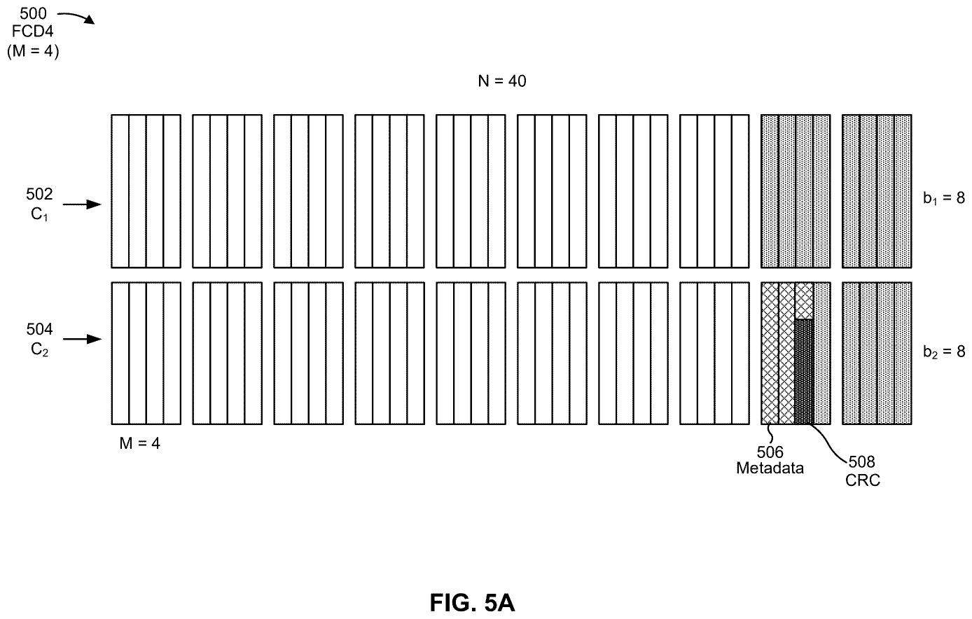

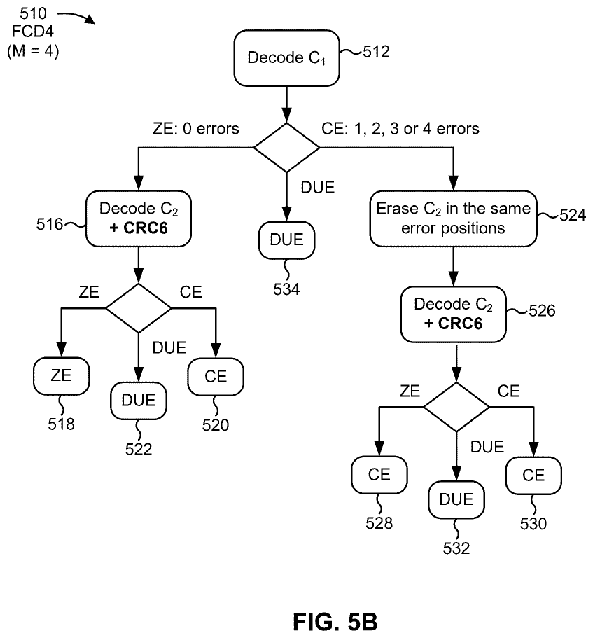

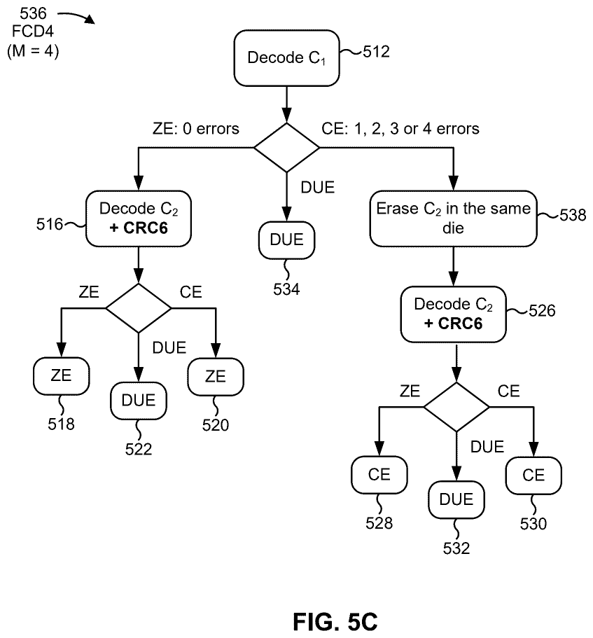

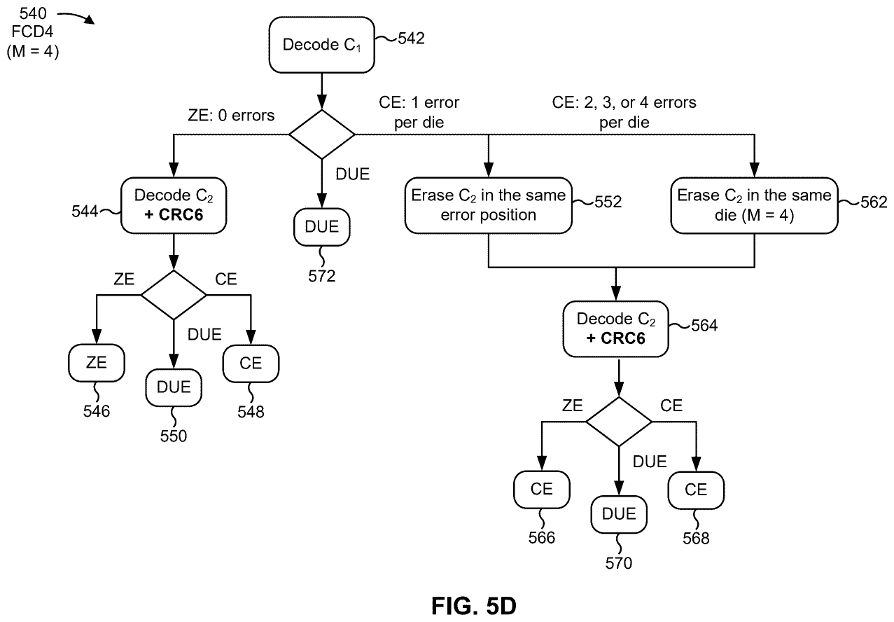

In some implementations, and as is described in more detail below, although the codewords 318, 320 may be associated with the same quantity of symbols 326 (e.g., N), a size of each symbol 326 associated with the first codeword 318 may differ from a size of each symbol 326 associated with the second codeword 320. More particularly, the symbols 326 associated with the first codeword 318 may include a first quantity of bits (sometimes referred to herein as b₁), and the symbols 326 associated with the second codeword 320 may include a second quantity of bits (sometimes referred to herein as b₂), with b₁≠b₂. In some implementations, M×(b₁+b₂) may be equal to a size of a single-die prefetch operation associated with the memory system. For example, in some implementations, a size of a single-die prefetch operation associated with the data block 300 may be 64 bits, and thus M×(b₁+b₂)=64. In some other implementations, a size of each symbol 326 associated with the first codeword 318 may be the same as a size of each symbol 326 associated with the second codeword 320 (e.g., b₁=b₂), which is described in more detail below in connection with FIG. 5A.

In some implementations, a specific FCD scheme may be referred to herein as an FCDM scheme. For example, when M=1, a corresponding FCD scheme may be referred to as an FCD1 scheme. Similarly, when M=2, a corresponding FCD scheme may be referred to as an FCD2 scheme, and when M=4, a corresponding FCD scheme may be referred to as an FCD4 scheme. In such implementations, an FCD1 scheme may have a relatively low decoding complexity, an FCD2 scheme may have a medium decoding complexity, and/or an FCD4 scheme may have a relatively high decoding complexity. Additionally, or alternatively, an FCD1 scheme may be associated with a symbol size (e.g., m) of 46 bits for the first codeword 318 and 18 bits for the second codeword (e.g., b₁=46 and b₂=18), a codeword length (e.g., N) of 10 symbols for the first codeword and the second codeword, a payload size and/or data length (e.g., K) of 8 symbols for the first codeword 318 and 9 symbols for the second codeword 320 (e.g., the second codeword 320 may have a larger payload because the second codeword 320 may be associated with 18 bits of metadata 322), and/or a Galois field size (e.g., q) of 2⁴⁶ for the first codeword 318 and 2¹⁸ for the second codeword 320. Moreover, an FCD2 scheme may be associated with a symbol size (e.g., m) of 14 bits for the first codeword 318 and 18 bits for the second codeword (e.g., b₁=14 and b₂=18), a codeword length (e.g., N) of 20 symbols for the first codeword 318 and the second codeword, a payload size and/or data length (e.g., K) of 16 symbols for the first codeword 318 and 17 symbols for the second codeword 320, and/or a Galois field size (e.g., q) of 2¹⁴ for the first codeword 318 and 2¹⁸ for the second codeword 320. Furthermore, an FCD4 scheme may be associated with a symbol size (e.g., m) of 7 bits for the first codeword 318 and 9 bits for the second codeword (e.g., b₁=7 and b₂=9), a codeword length (e.g., N) of 40 symbols for the first codeword 318 and the second codeword, a payload size and/or data length (e.g., K) of 32 symbols for the first codeword 318 and 34 symbols for the second codeword 320, and/or a Galois field size (e.g., q) of 2⁷ for the first codeword 318 and 2⁹ for the second codeword 320. In some other implementations, FCD1, FCD2, and/or FCD4 schemes may be associated with different parameters (e.g., different values of b₁, b₂, N, K, and/or q) without departing from the scope of the disclosure, which is described in more detail below in connection with FIG. 5A. Moreover, in some implementations, such as in FCD1 implementations (e.g., implementations in which M=1 and/or b₁+b₂=64 bits (e.g., the size of the single die prefetch)), two NBH codes may be used instead of two RS codes without departing from the scope of the disclosure.

In some implementations, an FCD scheme may be associated with detecting and/or correcting errors in the second codeword 320 (e.g., the weak codeword) based on detected and/or corrected errors in the first codeword 318 (e.g., the strong codeword). More particularly, an error correction engine or similar component (which is referred to herein simply as an ECC component for ease of discussion), which may be a dedicated component in the memory system, a portion of a memory system controller (e.g., a portion of CXL ASIC, among other examples), a component at a host system (e.g., a portion of a host processor), and/or a similar component, may receive the data block 300 and detect and/or correct one or more errors in the first codeword 318 using information in the first codeword 318 (e.g., the parity information and/or the payload of the first codeword 318). Based on the detected and/or corrected errors in the first codeword 318, the ECC component may identify locations of the second codeword 320 that may include one or more errors. For example, a detected error at a certain symbol location in the first codeword 318 may be indicative of a problem at the corresponding symbol location in the second codeword 320 (sometimes referred to herein as a “DQ-aligned failure”). Additionally, or alternatively, a cluster of errors at a certain die in the first codeword 318 may be indicative of a problem with the die (e.g., a failed die), which in turn may cause similar errors at the corresponding die location in the second codeword 320.

Accordingly, in some implementations, the ECC component may set one or more erasure conditions in the second codeword 320 based on the detected and/or corrected errors in the first codeword 318. As used herein, “erasure” refers to a situation where a location of a data error is known or identified, although the exact nature (e.g., whether the stored bit is a “0” or a “1”) of the error might not be known. Put another way, “erasure” refers to an identified location in a codeword where an error may have occurred, but the correct value is unknown. In that regard, and unlike generic errors where both the location and the value may need to be determined, an erasure focuses on errors for which the problematic location has been pinpointed. This knowledge may be useful in error correction schemes because it simplifies the process of correcting the error. Moreover, as used herein, “erasure condition” refers a state or scenario in a memory system where specific symbol locations (e.g., bit or memory cell positions) are marked as “erased” because an error in those locations is either suspected or confirmed. Put another way, “erasure condition” refers to a marked state within a codeword where specific locations are flagged as containing potential or confirmed errors, guiding the error correction mechanism in its operations. In that regard, the erasure condition indicates that these symbol locations should be treated by error correction algorithms with the understanding that they contain errors. These conditions inform the error correction mechanism to focus its efforts on the known-erroneous locations, which enhances the efficiency and effectiveness of the error correction process.

Accordingly, based on identified symbol and/or die locations in the first codeword 318 that contain one or more errors, the ECC component may set one or more erasure conditions in the second codeword 320 at symbol and/or die locations corresponding to the errors detected in the first codeword 318 (e.g., that share a positional relationship with the symbol and/or die locations having errors in the first codeword 318). The ECC component may then correct the one or more erasure conditions in the second codeword 320 using information in the second codeword 320 (e.g., the parity information and/or remaining payload bits in the second codeword 320).

In some implementations, FCD may be associated with a chipkill-based strategy (and thus may be referred to herein as a chipkill-based FCD scheme), while, in some other implementations, an FCD scheme may be associated with a DQ-based strategy (and thus may be referred to herein as a DQ-based FCD scheme). “Chipkill-based strategy” may refer to an approach used by the ECC component when a chipkill error is an expected error and/or a most common type of error experienced in a given memory system. In a chipkill-based strategy, the first codeword 318 may be decoded to detect one or more errors at a certain die (which, in some implementations, may be indicative that the entire die has failed), and an erasure condition may be set in the second codeword 320 at all M symbols of the second codeword 320 associated with the same die. The second codeword 320 may then be decoded, such as by correcting the erasure condition at the erased die using the payload and parity information of the second codeword 320. In such implementations, a chipkill-based strategy may provide chipkill protection unless the chipkill event contaminates the metadata codeword (e.g., the weak codeword) only.

On the other hand, “DQ-based strategy” may refer to an approach used when a DQ-aligned failure is an expected error and/or a most common type of error experienced in a given memory system. In some implementations, a DQ-based strategy may be available only when M≥2 (e.g., the DQ-based strategy may not be available for FCD1 schemes). In a DQ-based strategy, the first codeword 318 may be decoded to detect one or more errors at certain symbol positions (which, in some implementations, may be indicative of a DQ-aligned failure), and an erasure condition may be set in the second codeword 320 at the same symbol locations. The second codeword 320 may then be decoded, such as by correcting the erasure condition at the erased symbol locations using the payload and parity information of the second codeword 320.

In some implementations, an ECC component may employ both a chipkill-based approach and a DQ-based approach (e.g., an FCD scheme may combine a chipkill-based strategy and a DQ-base strategy). For example, for certain FCD schemes, such as for FCD schemes when M>2, a DQ-based strategy may be used when a single symbol error is detected in the first codeword 318, and a chipkill-based strategy may be used when more than one symbol error is detected in the first codeword 318. In such implementations, the first codeword 318 may be decoded to detect one or more errors at certain symbol positions. When one symbol error is detected, an erasure condition may be set in the second codeword 320 at the same symbol location. When more than one symbol error is detected, such as when multiple symbol errors associated with a same die are detected, an erasure condition may be set in the second codeword 320 at all M symbols of the second codeword 320 associated with the same die. The second codeword 320 may then be decoded, such as by correcting the erasure conditions at the one or more erased symbol locations using the payload and parity information of the second codeword 320.

The above will be more readily understood with reference to FIGS. 3D-3H, which illustrate example chipkill-based FCD schemes and DQ-based FCD schemes, according to some implementations.

More particularly, FIG. 3D illustrates an example chipkill-based FCD1 scheme 328. In some implementations, the chipkill-based FCD1 scheme 328 may be associated with a low decoding complexity (e.g., as compared to other FCD schemes described herein), a low silent data corruption (SDC) rate (e.g., as compared to other FCD schemes described herein), and/or a low failure probability of a chipkill event (e.g., as compared to other FCD schemes described herein). As indicated by reference number 329, the chipkill-based FCD1 scheme 328 may be associated with ten dies (e.g., ten DRAM components), and, for each codeword, a single symbol may correspond to each die (e.g., N=10 and M=1). In some implementations, and as further shown by reference number 329, the chipkill-based FCD1 scheme 328 may be associated with a symbol size (e.g., m) of 46 bits for the first codeword 318 and 18 bits for the second codeword (e.g., b₁=46 and b₂=18), and/or a payload size (e.g., K) of 8 symbols for the first codeword 318 and 9 symbols for the second codeword 320.

As indicated by reference number 330, an ECC component implementing the chipkill-based FCD1 scheme 328 may decode the first codeword 318 and may determine whether the first codeword 318 includes zero errors (ZE), one correctable error (CE), or at least one detected uncorrectable error (DUE). As indicated by reference number 332, when it is determined that the first codeword 318 contains ZE, the ECC component may decode the second codeword 320 and may determine whether the second codeword 320 contains any errors. When the ECC component determines that the second codeword 320 contains ZE, the chipkill-based FCD1 scheme 328 may end and/or may return a ZE status, as indicated by reference number 334. However, when it is determined that the second codeword 320 contains at least one DUE, the chipkill-based FCD1 scheme 328 may return a DUE status, as indicated by reference number 336.

On the other hand, and as indicated by reference number 338, when it is determined that the first codeword 318 contains one CE, the ECC component implementing the chipkill-based FCD1 scheme 328 may erase (e.g., set an erasure condition) in the same error position (e.g., at the same die) in the second codeword 320. As indicated by reference number 340, the error correction engine or similar component implementing the chipkill-based FCD1 scheme 328 may then decode the second codeword 320. If ZE are detected when decoding the second codeword 320, the chipkill-based FCD1 scheme 328 may end with one detected CE (e.g., the CE identified in the first codeword 318), as indicated by reference number 342. In such implementations, when decoding the second codeword 320 following an erasure condition being set in the same error position as the first codeword, the error may be assumed to be positioned in the symbol location in which the erasure condition was set (e.g., the symbol location at which the CE was detected in the first codeword 318) and thus may be corrected using the information in the second codeword 320 (e.g., the payload and parity information of the second codeword 320). In this regard, the chipkill-based FCD1 scheme 328 may be capable of correcting up to one erasure condition (e.g., one symbol and/or die erasure) in the second codeword 320. Moreover, when it is determined that the first codeword 318 contains at least one DUE, the chipkill-based FCD1 scheme 328 may end with at least one DUE, as indicated by reference number 344.

FIG. 3E illustrates an example DQ-based FCD2 scheme 346. In some implementations, the DQ-based FCD2 scheme 346 may be associated with a medium decoding complexity (e.g., as compared to other FCD schemes described herein), a low annualized failure rate (AFR) (e.g., as compared to other FCD schemes described herein), a multi-chip error correction capability, and/or a resistance against one or more DQ-aligned failures. As indicated by reference number 347, in some implementations the DQ-based FCD2 scheme 346 may be associated with ten dies (e.g., ten DRAM components) and, for each codeword, two symbols per die (e.g., N=20 and M=2). In some implementations, and as further shown by reference number 329, the DQ-based FCD2 scheme 346 may be associated with a symbol size (e.g., m) of 14 bits for the first codeword 318 and 18 bits for the second codeword (e.g., b₁=14 and b₂=18), and/or a payload size (e.g., K) of 16 symbols for the first codeword 318 and 17 symbols for the second codeword 320.

As indicated by reference number 348, an ECC component implementing the DQ-based FCD2 scheme 346 may decode the first codeword 318 and may determine whether the first codeword 318 includes ZE, one or two CEs, or at least one DUE. As indicated by reference number 350, when it is determined that the first codeword 318 contains ZE, the ECC component may decode the second codeword 320 and determine whether the second codeword 320 contains ZE, one CE, or at least one DUE. When it is determined that the second codeword 320 contains ZE, the DQ-based FCD2 scheme 346 may end with ZE, as indicated by reference number 352. When it is determined that the second codeword 320 contains a CE, the DQ-based FCD2 scheme 346 may correct the error in the second codeword 320 and thus the DQ-based FCD2 scheme 346 may end with one CE, as indicated by reference number 354. However, when it is determined that the second codeword 320 contains at least one DUE, the DQ-based FCD2 scheme 346 may end with DUE, as indicated by reference number 356.

On the other hand, and as indicated by reference number 358, when it is determined that the first codeword 318 contains one or two CEs, the ECC component may erase (e.g., set an erasure condition) in the same error positions (e.g., the same symbol locations and/or the same DQ locations) in the second codeword 320. As indicated by reference number 360, the ECC component may then decode the second codeword 320. If ZE are detected when decoding the second codeword 320, the DQ-based FCD2 scheme 346 may end with one detected CE (e.g., the CE identified in the first codeword 318), as indicated by reference number 362. If a CE is detected when decoding the second codeword 320, the DQ-based FCD2 scheme 346 may end with multiple detected CEs (e.g., the one or two CEs detected in the first codeword 318 as well as the CE detected in the second codeword 320), as indicated by reference number 364. In this regard, the DQ-based FCD2 scheme 346 may be capable of correcting up to one error in the second codeword 320, up to three erasure conditions (e.g., three symbol erasures) in the second codeword 320, or one error in the second codeword and one erasure condition in the second codeword 320. However, when it is determined that the second codeword 320 contains at least one DUE, the DQ-based FCD2 scheme 346 may end with DUE, as indicated by reference number 366. Similarly, when it is determined that the first codeword 318 contains at least one DUE, the DQ-based FCD2 scheme 346 may end with DUE, as indicated by reference number 368.

FIG. 3F illustrates an example of a chipkill-based FCD2 scheme 370. In a similar manner as the DQ-based FCD2 scheme 346 described above, the chipkill-based FCD2 scheme 370 may be associated with a medium decoding complexity (e.g., as compared to other FCD schemes described herein), a low AFR (e.g., as compared to other FCD schemes described herein), a multi-chip error correction capability, and/or a resistance against one or more DQ-aligned failures. Moreover, the operations described above in connection with reference numbers 350, 352, 354, 356, 360, 362, 364, 366, and 368 of the DQ-based FCD2 scheme 346 may be performed in a substantially similar manner for the chipkill-based FCD2 scheme 370, and thus are labeled with the same reference numbers in FIG. 3E and are not described again in detail. However, in this implementation, when it is determined that the first codeword 318 contains one or two CEs, the ECC component may erase (e.g., set an erasure condition) at all M symbol locations (e.g., two symbol locations) in the same die in the second codeword 320, as indicated by reference number 372. Put another way, in this implementation the ECC component may identify one or two CEs on a certain die of the first codeword 318, and, in response, may set erasure conditions at all symbol locations (e.g., both symbol locations) in the second codeword 320 that are associated with that die. In this way, the chipkill-based FCD2 scheme 370 may be capable of correcting up to one error in the second codeword 320, up to three erasure conditions (e.g., three symbol erasures) in the second codeword 320, or one error in the second codeword and one erasure condition in the second codeword 320.

In some implementations, similar operations as described above in connection with the DQ-based FCD2 scheme 346 and/or the chipkill-based FCD2 scheme 370 may be implemented for an FCD4 scheme. For example, as shown in FIG. 3G, and as indicated by reference number 374, in some implementations an FCD4 scheme may be associated with ten dies (e.g., ten DRAM components) and, for each codeword, four symbols per die (e.g., N=40 and M=4). In some implementations, the FCD4 scheme may be associated with a symbol size (e.g., m) of 7 bits for the first codeword 318 and 9 bits for the second codeword (e.g., b₁=7 and b₂=9, with two 9-bit symbols being used to provide 18 bits of metadata, as shown in FIG. 3G), and/or a payload size (e.g., K) of 32 symbols for the first codeword 318 and 34 symbols for the second codeword 320.

In such implementations, an FCD4 scheme may be employed using a DQ-based strategy or a chipkill-based strategy. The DQ-based FCD4 scheme and/or the chipkill-based FCD4 scheme may be associated with a high decoding complexity (e.g., as compared to other FCD schemes described herein), a low AFR (e.g., as compared to other FCD schemes described herein), a multi-chip error correction capability, and/or a resistance against one or more DQ-aligned failures. For a DQ-based FCD4 scheme, the operations may be substantially similar to those described above in connection with FIG. 3E; however, when 1, 2, 3, or 4 CEs are detected in the first codeword 318, the ECC component may erase symbol locations (e.g., set erasure conditions) at the corresponding one, two, three, or four symbol locations in the second codeword 320 (as compared to the one or two symbol locations as described above in connection with reference number 358 of FIG. 3E). For a chipkill-based FCD4 scheme, the operations may be substantially similar to those described above in connection with FIG. 3F; however, when 1, 2, 3, or 4 CEs are detected at a single die (e.g., a single DRAM component) in the first codeword 318, the ECC component may erase all M symbols (e.g., all four symbols) at the corresponding die location in the second codeword 320 (e.g., in a similar manner as described above in connection with reference number 372 of FIG. 3F). In this way, the DQ-based FCD4 scheme and/or the chipkill-based FCD4 scheme may be capable of correcting up to three errors in the second codeword 320, up to six erasure conditions (e.g., six symbol erasures) in the second codeword 320, one error in the second codeword 320 and four erasure conditions in the second codeword 320, or two errors in the second codeword 320 and two erasure conditions in the second codeword 320.

In some other implementations, an FCD4 scheme may be associated with a DQ-based strategy when a certain quantity of errors (e.g., one error) are detected in the first codeword 318, and may be associated with a chipkill-based strategy when a different quantity of errors (e.g., more than one error) are detected in the first codeword 318. In some implementations, this may be referred to as an optimized DQ-based strategy. For example, FIG. 3H shows an example of an optimized DQ-based FCD4 scheme 376. In some implementations, the optimized DQ-based FCD4 scheme 376 may be associated with a high decoding complexity (e.g., as compared to other FCD schemes described herein), a low AFR (e.g., as compared to other FCD schemes described herein), a multi-chip error correction capability, and/or a resistance against one or more DQ-aligned failures.

As indicated by reference number 378, an ECC component implementing the optimized DQ-based FCD4 scheme 376 may decode the first codeword 318 and may determine whether the first codeword 318 includes ZE, one through four CEs, or at least one DUE. As indicated by reference number 380, when it is determined that the first codeword 318 contains ZE, the ECC component may decode the second codeword 320 and determine whether the second codeword 320 contains ZE, a CE, or at least one DUE. When it is determined that the second codeword 320 contains ZE, the optimized DQ-based FCD4 scheme 376 may end with ZE, as indicated by reference number 381. When it is determined that the second codeword 320 contains a CE, the optimized DQ-based FCD4 scheme 376 may correct the error in the second codeword 320, and thus the optimized DQ-based FCD4 scheme 376 may end with CE, as indicated by reference number 382. However, when it is determined that the second codeword 320 contains at least one DUE, the optimized DQ-based FCD4 scheme 376 may end with DUE, as indicated by reference number 383.

On the other hand, and as indicated by reference number 384, when it is determined that the first codeword 318 contains only one CE in a given die, the ECC component may erase (e.g., set an erasure condition) in the same error position (e.g., the same symbol location and/or the same DQ location) in the second codeword 320. Moreover, when it is determined that the first codeword 318 contains two, three, or four CEs in a given die, the ECC component may erase (e.g., set an erasure condition) at all M symbol locations (e.g., four symbol locations) in the same die in the second codeword 320, as indicated by reference number 389. Put another way, in this implementation the ECC component may identify two, three, or four CEs on a certain die of the first codeword 318, and, in response, may set erasure conditions at all symbol locations (e.g., all four symbol locations) in the second codeword 320 that are associated with that die.

As indicated by reference number 390, the ECC component may then decode the second codeword 320. If ZE are detected when decoding the second codeword 320, the optimized DQ-based FCD4 scheme 376 may end with two, three, or four detected CEs (e.g., the two, three, or four CEs identified in the first codeword 318), as indicated by reference number 391. If a CE is detected when decoding the second codeword 320, the optimized DQ-based FCD4 scheme 376 may end with multiple detected CEs (e.g., the two, three, or four CEs detected in the first codeword 318 and well as the CE detected in the second codeword 320), as indicated by reference number 392. However, when it is determined that the second codeword 320 contains at least one DUE, the optimized DQ-based FCD4 scheme 376 may end with DUE, as indicated by reference number 393. Moreover, when more erasure conditions are added to the second codeword 320 than can be successfully corrected by the second codeword 320 (e.g., if the added erasures to the second codeword 320 are more than what the second codeword 320 decoder supports), the optimized DQ-based FCD4 scheme 376 may end with DUE. Similarly, when it is determined that the first codeword 318 contains at least one DUE, the optimized DQ-based FCD4 scheme 376 may end with DUE, as indicated by reference number 394.

As described above, in some examples the optimized DQ-based FCD4 scheme 376 may result in more erasure conditions being set in the second codeword 320 than can be successfully corrected by the second codeword 320, resulting in DUE. Accordingly, rather than setting erasure conditions at all four symbol locations of a given die in the second codeword 320, in some implementations an ECC component (e.g., a decoder of the second codeword 320) may set erasure conditions at three symbol locations in the second codeword 320. More particularly, in some implementations, the optimized DQ-based FCD4 scheme 376 may be capable of correcting up to three erasure conditions plus one error in the second codeword 320. In such aspects, if all symbol locations on a given die are associated with erasure conditions (resulting in four erasure conditions), the second codeword 320 may not be capable of correcting any additional errors detected in the second codeword 320, thus resulting in DUE in that case. Thus, if at least one more symbol (e.g., a symbol on a different die than the die for which erasure conditions were set) includes an error, the second codeword 320 decoder encounters DUE.

Accordingly, in some implementations, rather than setting erasure conditions at all symbol locations (e.g., all four symbol locations) of a die when an error is detected in a corresponding symbol location in the first codeword 318, erasure conditions may be set at three symbol locations in the second codeword 320, enabling the second codeword 320 decoder to successfully decode the second codeword 320 even if an error is detected in another symbol location of the second codeword 320 (either in the same die or at a different die). Put another way, in some implementations, if a single symbol error is detected in the first codeword 318, an erasure condition may be set in a symbol in the second codeword 320 that is in the same position of the error in the first codeword 318, and erasure conditions may also be set at two other symbols, chosen at random, from the same prefetch.

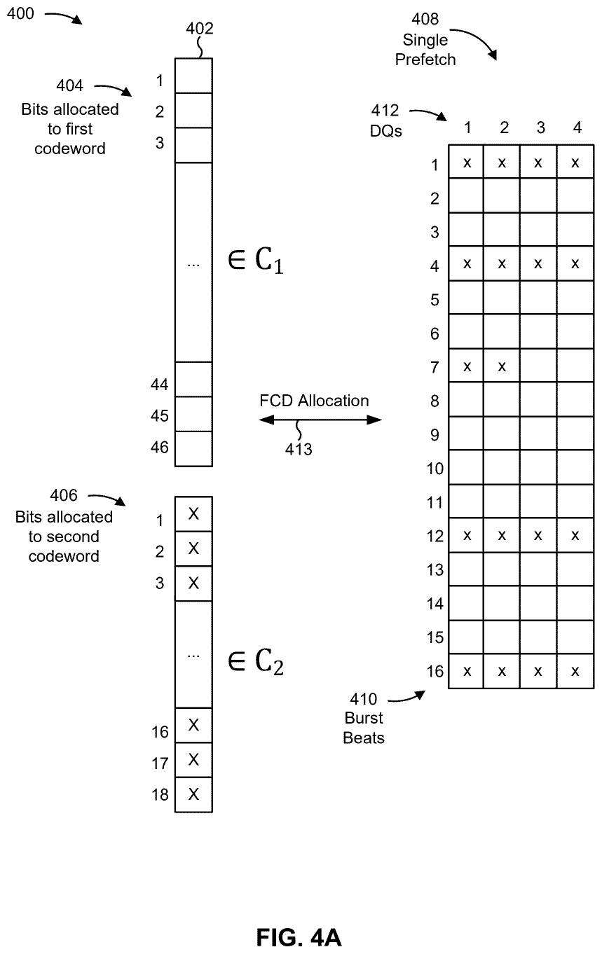

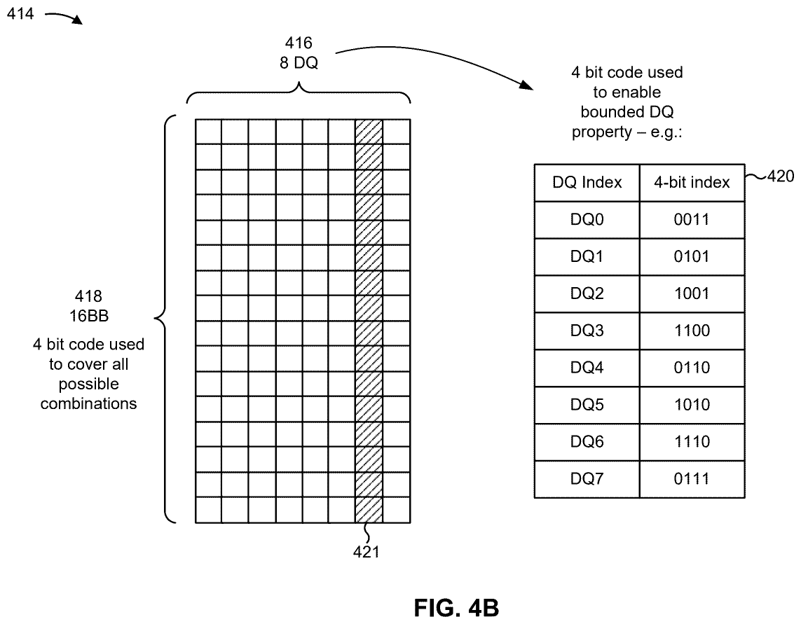

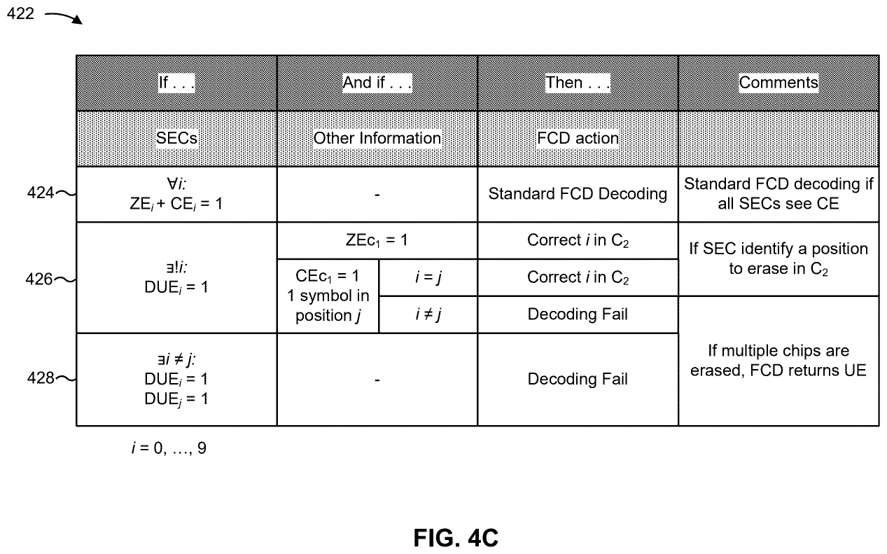

In some implementations, one or more of the above-described FCD schemes may be implemented in connection with other error detection and/or correction capabilities of a memory system, thereby enabling optimized error detection and/or correction schemes. Examples of such optimized error detection and/or correction schemes are described below in connection with FIGS. 4A-5D.

As indicated above, FIGS. 3A-3H are provided as examples. Other examples may differ from what is described with regard to FIGS. 3A-3H.

FIGS. 4A-4C are diagrams of other examples of detecting errors in a data block using multiple codewords. The operations described in connection with FIGS. 4A-4C may be performed by the memory system 110 and/or one or more components of the memory system 110, such as the memory system controller 115, one or more memory devices 120, and/or one or more local controllers 125; the host system 105 and/or one or more components of the host system 105, such as the host processor 150; the CXL compliant memory system 204 and/or one or more components of the CXL compliant memory system 204 (e.g., a CXL ASIC), such as the main management subsystem 214, the CXL device attached memory 218, and/or one or more components of the CXL device attached memory 218; and/or the CXL host 202 and/or one or more components of the CXL host 202.

In some implementations, certain information associated with one or more dies (e.g., one or more of the data dies described above in connection with reference number 302 and/or the parity dies described above in connection with reference number 304) may be used in connection with an FCD scheme (e.g., one or more of the FCD schemes described above) in order to improve an error detection and/or correction capability of the FCD scheme. For example, in some implementations, a die (e.g., a DRAM component) may be associated with an on-die single error correction (OD-SEC) component and/or mechanism that is capable of correcting a single error on the die. In such implementations, side information from the OD-SEC component and/or mechanism may be provided to an ECC component implementing an FCD scheme for a purpose of improving the error correction and/or detection capability of the FCD scheme. For example, in some implementations, side information from the OD-SEC component may be used in connection with an FCD1 scheme (e.g., the chipkill-based FCD1 scheme 328) to reduce a quantity of harmful error patterns that may be otherwise uncorrectable by the FCD1 scheme.

More particularly, FIG. 4A shows an example 400 associated with allocating bits to a first codeword (e.g., C₁, which may correspond to the first codeword 318) and/or a second codeword (e.g., C₂, which may correspond to the second codeword 320) based on an OD-SEC implementation. As indicated by reference number 402, each single-die prefetch associated with a data block (e.g., data block 300) may include 64 bits, with 46 bits being allocated to the first codeword in this implementation (e.g., b₁=46), as indicated by reference number 404, and with 18 bits being allocated to the second codeword in this implementation (e.g., b₂=18), as indicated by reference number 406. Put another way, a single prefetch may be split into bits belonging to the strong codeword (e.g., C₁) and bits belonging to the weak codeword (e.g., C₂).

In some implementations, an error pattern may be harmful if it contaminates only bits belonging to the weak codeword (e.g., C₂) because, as described above in connection with FIGS. 3A-3H, an error detection and/or correction capability of the weak codeword may be reduced as compared to an error detection and/or correction capability of the strong codeword (e.g., C₁). Accordingly, bit allocations may be done in such a way that at-risk bits (e.g., bits susceptible to errors according to the OD-SEC implementation) are not only allocated to the weak codeword. More particularly, as indicated by reference number 408, a single-die prefetch may include accessing a quantity of burst beats (e.g., 16 burst beats in the example 400), as indicated by reference number 410, across a quantity of DQ pins (e.g., four in the example 400), as indicated by reference number 412. As indicated by reference number 413, the bits accessed by the prefetch (e.g., the 64 bits in this example) may be strategically allocated among the strong codeword and the weak codeword for FCD purposes, such as by allocating the bits having no marking in FIG. 4A to the strong codeword and/or by allocating the bits having an “X” in FIG. 4A to the weak codeword. This allocation may be based on the OD-SEC implementation to ensure that certain error patterns and/or problematic bits are not allocated solely to the weak codeword (e.g., C₂). Put another way, based on the OD-SEC implementation, there may be a favorable FCD allocation (e.g., how bits of the weak codeword are placed in the prefetch) that avoids specific harmful patterns from an FCD-viewpoint (e.g., that avoids patterns in which errors are contained only in the weak codeword).

Additionally, or alternatively, side information associated with an OD-SEC component may be used in connection with an FCD scheme (e.g., the chipkill-based FCD1 scheme 328), such as by signaling, by an OD-SEC component to an ECC component, that an uncorrectable error (UE) from an OD-SEC viewpoint (sometimes referred to as SEC-UE) has occurred in a given prefetch. In such implementations, an ECC component implementing an FCD scheme may set an erasure condition in a weak codeword at a symbol location associated with that prefetch, thereby enabling decoding of certain harmful error patterns that may otherwise go undetected. In some implementations, an OD-SEC component may signal, to an ECC component implementing an FCD scheme, that an SEC-UE has occurred in a certain prefetch using a single bit, sometimes referred to herein as I.

More particularly, as shown in FIG. 4B, and as indicated by reference number 414, certain OD-SEC schemes may be associated with a bounded SEC scheme. The bounded SEC scheme may be associated with an SEC(136, 128) code (e.g., an SEC code that encodes 128 bits of data into 136 bits by adding 8 parity bits) obtained by shortening a Hamming(255, 247) code (e.g., a Hamming code that encodes 247 bits of data into 255 bits by adding 8 parity bits). In such examples, the 128-bit payload may be partitioned into eight DQ regions, as indicated by reference number 416, each associated with 16 burst beats (BB), as indicated by reference number 418. A syndrome (sometimes referred to herein as S, which may be a vector that indicates the presence and position of errors in the received data) associated with the bounded SEC scheme may be eight bits wide, with a first set of four bits corresponding to a DQ location of the error (sometimes referred to herein as S_{DQ}) and second set of four bits corresponding to a BB location of the error (sometimes referred to herein as S_{BB}). Put another way, S=(S_{DQ}, S_{BB}). In such implementations, S_{BB} may be a four-bit code used to cover all possible combinations of a BB location (e.g., all 16 BB locations), and/or S_{DQ} may be a four-bit code used to cover the eight DQ locations. In some implementations, although three bits would be enough to cover the eight DQ locations, four bits may be used to enable a bounded DQ property. In such implementations, no 0000 code may be used and/or no weight 1 patterns may be used. For example, reference number 420 indicates example 4-bit codes that may be used to indicate eight DQ positions, indexed DQ0 through DQ7 in the table indicated by reference number 420.

In such implementations, a bounded property of the SEC structure enables the OD-SEC component to restrict a mis-correction in the same DQ region, such as the seventh DQ region (e.g., a region indexed as DQ6), as indicated by reference number 421 and as shown using hatching in FIG. 4B, if only one DQ region is affected by errors. For example, if an odd number of bit errors occur in a DQ region, S_{DQ} may be preserved, and if an even number of bit errors occur in a DQ region, S_{DQ} may be set to zero. Accordingly, if S_{DQ}=0 and S_{BB}≠0 (and thus S≠0), then a prefetch has some errors, and thus it may be beneficial to set an erasure condition at the location in the weak codeword associated with the prefetch. This condition may be signaled by the OD-SEC component to an ECC component employing an FCD scheme, using one bit (e.g., I). For example, if S≠0 for a given prefetch, I=1 may be signaled to the ECC component implementing the FCD scheme, and the ECC component may in turn set an erasure condition in the weak codeword at a symbol location and/or die location associated with that prefetch.

FIG. 4C shows a table 422 that summarizes how error correction may be employed using both on information associated with an OD-SEC component and an FCD scheme (e.g., a chipkill-based FCD1 scheme 328), according to some implementations. In the example shown in FIG. 4C, i may refer to a die index, and thus may correspond to one of 0 through 9 in examples involving 10 dies indexed as Die 0 through Die 9. As shown in the first row indicated by reference number 424, if one or more OD-SEC components associated with the dies determine that there is ZE for each die or at most one CE for each die (shown in FIG. 4C as “∀i: ZEᵢ+CEᵢ=1”), then an ECC component may proceed with standard FCD decoding (e.g., using the chipkill-based FCD1 scheme 328, among other examples). Put another way, when the one or more OD-SEC components detect at most one CE at each die, the OD-SEC may simply correct the error and the FCD scheme may proceed as described above in connection with FIG. 3D.

As shown in the second row indicated by reference number 426, if one or more OD-SEC components associated with the dies determine that there is exactly one die for which there is a DUE (shown in FIG. 4C as “∃!i: DUEᵢ=1”), and the ECC component detects ZE in the first codeword (e.g., C₁) associated with the FCD scheme (shown in FIG. 4C as “ZEc₁=1”), then the ECC component may correct the error in the second codeword (e.g., C₂) using FCD decoding. In some cases, this may include setting an erasure condition in a position in the second codeword that is identified by the OD-SEC components (e.g., this may include setting an erasure condition at the i^{th} symbol location in C₂).

As further shown in the second row indicated by reference number 426, if the one or more OD-SEC components determine that there is exactly one die for which there is a DUE (e.g., ∃!i: DUEᵢ=1), the ECC component detects a CE at die j in the first codeword (shown in FIG. 4C as “CEc₁=1”), and the ECC component detects that the die for which the DUE was detected using the one or more OD-SEC components is the same die for which the CE is detected using FCD decoding (shown in FIG. 4C as “i=j”), then the ECC component may correct the error in the second codeword using FCD decoding. In some cases, this may include setting an erasure condition in a position in the second codeword that is identified by the OD-SEC components (e.g., setting an erasure condition at the i^{th} symbol location in C₂).

As further shown in the second row indicated by reference number 426, if the one or more OD-SEC components determine that there is exactly one die for which there is a DUE (e.g., ∃!i: DUEᵢ=1), the ECC component detects a CE at die j in the first codeword associated with the FCD scheme (e.g., CEc₁=1), and the ECC component detects that the die for which the DUE was detected using the one or more OD-SEC components is not the same die for which the CE is detected using FCD decoding (shown in FIG. 4C as “i≠j”), then the ECC component may determine that a decoding fail has occurred. This may be because the FCD scheme may be capable of correcting errors/erasures associated with a single die, as described above in connection with FIG. 3D, and in this instance there would be corrections needed at two different die locations (e.g., at dies i and j, with i≠j). Put another way, if multiple symbol locations in the second codeword are associated with erasure conditions (e.g., one set in response to the information associated with an OD-SEC component and another one set in response to a detected error in the first codeword during FCD decoding), the FCD scheme may return a UE.

Finally, as shown in the row indicated by reference number 428, if the one or more OD-SEC components determine that there exists a DUE in at least two different dies (shown in FIG. 3C as “∃!i≠j: DUEᵢ=1 DUEⱼ=1”), then the ECC component may similarly determine that a decoding fail has occurred. Again, this is because, in such a situation, multiple symbol locations in the second codeword would be associated with erasure conditions (e.g., one set in response to the side information received from the OD-SEC component and another one set in response to a detected error in the first codeword during FCD decoding), and multiple erasure conditions in the second codeword may be uncorrectable using FCD1 decoding.

As indicated above, FIGS. 4A-4C are provided as examples. Other examples may differ from what is described with regard to FIGS. 4A-4C.

FIGS. 5A-5D are diagrams of other examples of detecting errors in a data block using multiple codewords. The operations described in connection with FIGS. 5A-5D may be performed by the memory system 110 and/or one or more components of the memory system 110, such as the memory system controller 115, one or more memory devices 120, and/or one or more local controllers 125; the host system 105 and/or one or more components of the host system 105, such as the host processor 150; the CXL compliant memory system 204 and/or one or more components of the CXL compliant memory system 204 (e.g., a CXL ASIC), such as the main management subsystem 214, the CXL device attached memory 218, and/or one or more components of the CXL device attached memory 218; and/or the CXL host 202 and/or one or more components of the CXL host 202.

In some implementations, a data block that is associated with an FCD scheme may further be associated with cyclic redundancy check (CRC) information, such as for a purpose of improving an error detection capability of the FCD scheme. For example, as shown in FIG. 5A, and as indicated by reference number 500, in some implementations an FCD4 scheme may be associated with ten dies (e.g., ten DRAM components) and, for each codeword, four symbols per die (e.g., N=40 and M=4), in a similar manner as described above in connection with FIG. 3G. In this implementation, however, the FCD4 scheme may be associated with a symbol size (e.g., m) of 8 bits for a first codeword 502 and for a second codeword 504 (e.g., b₁=b₂=8). Moreover, the second codeword 504 may include 18 bits of metadata 506 spread across two full symbols (comprising 16 of the 18 bits) and two bits of a third symbol, and six bits of CRC information 508 included at the remaining portion of the third symbol (e.g., the symbol including only two bits of the metadata 506). In such implementations, the first codeword 502 may include a payload size (e.g., K) of 32 symbols, and the second codeword 504 may include a payload size of 35 symbols (e.g., 32 symbols of user data, and three symbols of metadata 506 and CRC information 508). In such implementations, the six bits of CRC information 508 may be used to perform a CRC (sometimes referred to herein as “CRC6,” with the “6” indicative that six bits are used for the CRC) on the second codeword 504, which may result in an FCD4 scheme that has a lower SDC rate that other FCD4 schemes described herein.

More particularly, FIG. 5B illustrates an example DQ-based FCD4 scheme 510 that utilizes CRC6. In some implementations, the DQ-based FCD4 scheme 510 may be associated with a high decoding complexity (e.g., as compared to other FCD schemes described herein), both a low AFR and a low SDC rate due to the presence of CRC6 (e.g., as compared to other FCD schemes described herein), a multi-chip error correction capability, and/or a resistance against one or more DQ-aligned failures.

As indicated by reference number 512, an ECC component implementing the DQ-based FCD4 scheme 510 may decode the first codeword 502 and may determine whether the first codeword 502 includes ZE, one through four CEs, or at least one DUE. As indicated by reference number 516, when it is determined that the first codeword 502 contains ZE, the ECC component may decode the second codeword 504, and, as part of the decoding process, may perform a CRC6 check, thereby improving the error detection capability of the DQ-based FCD4 scheme 510 as compared to other FCD4 schemes described herein. Based on the decoding and/or CRC6 check, the ECC component may determine whether the second codeword 504 contains ZE, a CE, or at least one DUE. When it is determined that the second codeword 504 contains ZE, the DQ-based FCD4 scheme 510 may end with ZE, as indicated by reference number 518. When it is determined that the second codeword 504 contains a CE, the DQ-based FCD4 scheme 510 may end with CE, as indicated by reference number 520. However, when it is determined that the second codeword 504 contains at least one DUE, the DQ-based FCD4 scheme 510 may end with DUE, as indicated by reference number 522.

On the other hand, and as indicated by reference number 524, when it is determined that the first codeword 502 contains one, two, three, or four CEs, the ECC component may erase (e.g., set an erasure condition) in the same error positions (e.g., the same symbol locations and/or the same DQ locations) in the second codeword 504. As indicated by reference number 526, the ECC component may then decode the second codeword 504, and, as part of the decoding process, may perform a CRC6 check, thereby improving the error detection capability of the DQ-based FCD4 scheme 510 as compared to other FCD4 schemes described herein. If ZE are detected when decoding the second codeword 504 and/or performing the CRC6 check, the DQ-based FCD4 scheme 510 may end with one detected CE (e.g., the CE identified in the first codeword 502), as indicated by reference number 528. If a CE is detected when decoding the second codeword 504, the DQ-based FCD4 scheme 510 may end with multiple detected CEs (e.g., the one through four CEs detected in the first codeword 502 and well as the CE detected in the second codeword 504), as indicated by reference number 530. In this regard, the DQ-based FCD4 scheme 510 may be capable of correcting up to two errors and one erasure condition in the second codeword 504, up to five erasure conditions (e.g., five symbol erasures) in the second codeword 504, or any combination therebetween (e.g., one error and three erasure conditions in the second codeword 504). However, when it is determined that the second codeword 504 contains at least one DUE, the DQ-based FCD4 scheme 510 may end with DUE, as indicated by reference number 532. Similarly, when it is determined that the first codeword 502 contains at least one DUE, the DQ-based FCD4 scheme 510 may end with DUE, as indicated by reference number 534.

FIG. 5C illustrates an example of a chipkill-based FCD4 scheme 536 that implements CRC6, such as for a purpose of reducing an SDC rate associated with the FCD4 scheme. In that regard, and in a similar manner as the DQ-based FCD4 scheme 510 described above, the chipkill-based FCD4 scheme 536 may be associated with a high decoding complexity (e.g., as compared to other FCD schemes described herein), a low AFR as well as a low SDC rate (e.g., as compared to other FCD schemes described herein), a multi-chip error correction capability, and/or a resistance against one or more DQ-aligned failures. Moreover, the operations described above in connection with reference numbers 516, 518, 520, 522, 526, 528, 530, 532, and 534 of the DQ-based FCD4 scheme 510 may be performed in a substantially similar manner for the chipkill-based FCD4 scheme 536, and thus are labeled with the same reference numbers in FIG. 5C and are not described again in detail. However, in this implementation, when it is determined that the first codeword 502 contains one through four CEs, the ECC component implementing the chipkill-based FCD4 scheme 536 may erase (e.g., set an erasure condition) at all M symbol locations (e.g., four symbol locations) in the same die in the second codeword 504, as indicated by reference number 538. Put another way, in this implementation the error correction engine or similar component implementing the chipkill-based FCD4 scheme 536 may identify one, two, three, or four CEs on a certain die of the first codeword 502, and, in response, may set erasure conditions at all symbol locations (e.g., all four symbol locations) in the second codeword 504 that are associated with that die. In this way, the chipkill-based FCD4 scheme 536 may be capable of correcting up to two errors and one erasure condition in the second codeword 504, up to five erasure conditions (e.g., five symbol erasures) in the second codeword 504, or any combination therebetween (e.g., one error and three erasure conditions in the second codeword 504).

In some other implementations, and in a similar manner as described above in connection with FIG. 3H, an FCD4 scheme that employs a CRC6 check may be associated with a DQ-based strategy when a certain quantity of errors (e.g., one error) are detected in the first codeword 502, and may be associated with a chipkill-based strategy when a different quantity of errors (e.g., more than one error) are detected in the first codeword 502 (e.g., an FCD4 scheme employing a CRC6 check may use an optimized DQ-based strategy). For example, FIG. 5D shows an example of an optimized DQ-based FCD4 scheme 540 that further employs a CRC6 check to reduce an SDC rate, among other examples. In some implementations, the optimized DQ-based FCD4 scheme 540 may be associated with a high decoding complexity (e.g., as compared to other FCD schemes described herein), a low AFR and low SDC rate (e.g., as compared to other FCD schemes described herein), a multi-chip error correction capability, and/or a resistance against one or more DQ-aligned failures.

As indicated by reference number 542, an ECC component implementing the optimized DQ-based FCD4 scheme 540 may decode the first codeword 502 and may determine whether the first codeword 502 includes ZE, one through four CEs, or at least one DUE. As indicated by reference number 544, when it is determined that the first codeword 502 contains ZE, the ECC component may decode the second codeword 504, perform a CRC6 check, and determine whether the second codeword 504 contains ZE, a CE, or at least one DUE. When it is determined, based on decoding the second codeword 504 and performing the CRC6 check, that the second codeword 504 contains ZE, the optimized DQ-based FCD4 scheme 540 may end with ZE, as indicated by reference number 546. When it is determined that the second codeword 504 contains a CE, the optimized DQ-based FCD4 scheme 540 may end with CE, as indicated by reference number 548. However, when it is determined that the second codeword 504 contains at least one DUE, the optimized DQ-based FCD4 scheme 540 may end with DUE, as indicated by reference number 550.

On the other hand, and as indicated by reference number 552, when it is determined that the first codeword 502 contains only one CE in a given die, the ECC component may erase (e.g., set an erasure condition) in the same error position (e.g., the same symbol location and/or the same DQ location) in the second codeword 504. Moreover, when it is determined that the first codeword 502 contains two, three, or four CEs in a given die, the ECC component may erase (e.g., set an erasure condition) at all M symbol locations (e.g., four symbol locations) in the same die in the second codeword 504, as indicated by reference number 562. Put another way, in this implementation the ECC component may identify two, three, or four CEs on a certain die of the first codeword 502, and, in response, may set erasure conditions at all symbol locations (e.g., all four symbol locations) in the second codeword 504 that are associated with that die.

As indicated by reference number 564, the ECC component may then decode the second codeword 504 and/or perform a CRC6. If ZE are detected when decoding the second codeword 504 and/or following the CRC6, the optimized DQ-based FCD4 scheme 540 may end with two, three, or four detected CEs (e.g., the two, three, or four CEs identified in the first codeword 502), as indicated by reference number 566. If a CE is detected when decoding the second codeword 504, the optimized DQ-based FCD4 scheme 540 may end with multiple detected CEs (e.g., the two, three, or four CEs detected in the first codeword 502 and well as the CE detected in the second codeword 504), as indicated by reference number 568. However, when it is determined that the second codeword 504 contains at least one DUE, the optimized DQ-based FCD4 scheme 540 may end with DUE, as indicated by reference number 570. Moreover, when more erasure conditions are added to the second codeword 504 than can be successfully corrected by the second codeword 320 (e.g., if the added erasures to the second codeword 504 are more than what the second codeword 504 decoder supports), the optimized DQ-based FCD4 scheme 540 may end with DUE. Similarly, when it is determined that the first codeword 502 contains at least one DUE, the optimized DQ-based FCD4 scheme 540 may end with DUE, as indicated by reference number 572.

As described above, in some examples the optimized DQ-based FCD4 scheme 540 may result in more erasure conditions being set in the second codeword 504 than can be successfully corrected by the second codeword 504, resulting in DUE. Accordingly, rather than setting erasure conditions at all four symbol locations of a given die in the second codeword 504, in some implementations an ECC component (e.g., a decoder of the second codeword 504) may set erasure conditions at three symbol locations in the second codeword 504, in a similar manner as described above in connection with the optimized DQ-based FCD4 scheme 376. More particularly, because in this example N-K₂=5 for the second codeword 504, the optimized DQ-based FCD4 scheme 540 may be capable of correcting up to three erasure conditions plus one error in the second codeword 504. In such cases, if all symbol locations on a given die are associated with erasure conditions (resulting in four erasure conditions), the second codeword 504 may not be capable of correcting any additional errors detected in the second codeword 504, thus resulting in DUE in that case. Thus, if one or more symbol (e.g., a symbol on a different die than the die for which erasure conditions were set) includes an error, the second codeword 504 decoder encounters DUE.

Accordingly, in some implementations, rather than setting erasure conditions at all symbol locations (e.g., all four symbol locations) of a die when an error is detected in a corresponding symbol location in the first codeword 502, erasure conditions may be set at three symbol locations in the second codeword 504, enabling the second codeword 504 decoder to successfully decode the second codeword 504 even if an error is detected in another symbol location of the second codeword 504 (either in the same die or at a different die). Put another way, in some implementations, if a single symbol error is detected in the first codeword 502, an erasure condition may be set in a symbol in the second codeword 504 that is in the same position of the error in the first codeword 502, and erasure conditions may also be set at two other symbols, chosen at random, from the same prefetch.

As indicated above, FIGS. 5A-5D are provided as examples. Other examples may differ from what is described with regard to FIGS. 5A-5D.

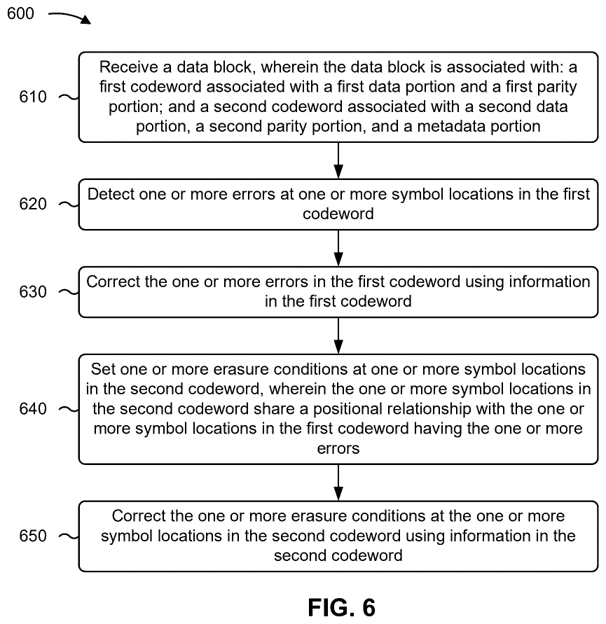

FIG. 6 is a flowchart of an example method 600 associated with detecting errors in a data block using multiple codewords. In some implementations, a memory system controller (e.g., the memory system controller 115, main management subsystem 214, and/or a CXL ASIC) may perform or may be configured to perform the method 600. In some implementations, another device or a group of devices separate from or including the memory system controller (e.g., memory system 110, memory device 120, local controller 125, host system 105, host processor 150, CXL compliant memory system 204, CXL device attached memory 218, and/or CXL host 202) may perform or may be configured to perform the method 600. Thus, means for performing the method 600 may include the memory system controller and/or one or more components of the memory system controller, the host system and/or one or more components of the host system, and/or other components described above in connection with FIGS. 1 and 2. Additionally, or alternatively, a non-transitory computer-readable medium may store one or more instructions that, when executed by the memory system controller, cause the memory system controller to perform the method 600.

As shown in FIG. 6, the method 600 may include receiving a data block, wherein the data block is associated with: a first codeword associated with a first data portion and a first parity portion; and a second codeword associated with a second data portion, a second parity portion, and a metadata portion (block 610). For example, the method 600 may include receiving the data block 300 associated with the first codeword 318 and the second codeword 320 and/or the data block described in connection with reference number 500 that includes the first codeword 502 and the second codeword 504.

As further shown in FIG. 6, the method 600 may include detecting one or more errors at one or more symbol locations in the first codeword (block 620). For example, the method 600 may include detecting one or more errors in the first codeword 318, 502 using one of the FCD schemes described above in connection with FIGS. 3A-5D.

As further shown in FIG. 6, the method 600 may include correcting the one or more errors in the first codeword using information in the first codeword (block 630). For example, the method 600 may include correcting the one or more errors in the first codeword 318, 502 using one of the FCD schemes described above in connection with FIGS. 3A-5D.

As further shown in FIG. 6, the method 600 may include setting one or more erasure conditions at one or more symbol locations in the second codeword, wherein the one or more symbol locations in the second codeword share a positional relationship with the one or more symbol locations in the first codeword having the one or more errors (block 640). For example, in DQ-based FCD implementations, the method 600 may include setting erasure conditions at the same symbol locations in the second codeword 320, 504, as described above in connection with FIGS. 3A-5D. Moreover, in chipkill-based FCD implementations, the method 600 may include setting erasure conditions at all M symbol locations in the second codeword 320, 504 associated with a same die containing errors in the first codeword 318, 502, as described above in connection with FIGS. 3A-5D.

As further shown in FIG. 6, the method 600 may include correcting the one or more erasure conditions at the one or more symbol locations in the second codeword using information in the second codeword (block 650). For example, the method 600 may include correcting the one or more erasure conditions in the second codeword 320, 504 using one of the FCD schemes described above in connection with FIGS. 3A-5D.

The method 600 may include additional aspects, such as any single aspect or any combination of aspects described below and/or described in connection with one or more other methods or operations described elsewhere herein.

In a first aspect, a quantity of bits per symbol associated with the first codeword differs from a quantity of bits per symbol associated with the second codeword. For example, the method 600 may include implementing an FCD scheme for which b₁≠b₂, such as implementing one of the FCD schemes described above in connection with FIGS. 3A-4C.

In a second aspect, alone or in combination with the first aspect, the first codeword and the second codeword are associated with a same total quantity of symbols, and the total quantity of symbols divided by a quantity of the multiple memory devices is equal to one of 1, 2, or 4. For example, the method 600 may include implementing an FCD1 scheme (e.g., M=1, which corresponds to the total quantity of symbols divided by the quantity of the multiple memory devices), an FCD2 scheme (e.g., M=2), or an FCD4 scheme (e.g., M=4), as described above in connection with FIGS. 3A-5D.

In a third aspect, alone or in combination with one or more of the first and second aspects, when the total quantity of symbols divided by the quantity of the multiple memory devices is equal to 1, the first codeword and the second codeword are associated with one of RS codes or NBH codes, and when the total quantity of symbols divided by the quantity of the multiple memory devices is equal to one of 2 or 4, the first codeword and the second codeword are associated with RS codes. For example, as described above in connection with FIGS. 3A-5D, when M=1 (e.g., when an FCD1 scheme is employed), either RS codes or NBH codes may be used for error correction, and when M=2 or 4 (e.g., when an FCD2 scheme or FCD4 scheme is employed), RS codes may be used for error correction.

In a fourth aspect, alone or in combination with one or more of the first through third aspects, the one or more errors are associated with a single memory device, of the multiple memory devices, and setting the one or more erasure conditions at the one or more symbol locations in the second codeword includes setting erasure conditions at all symbols in the second codeword that are associated with the single memory device. For example, in some implementations an FCD scheme may use a chipkill-based strategy in which erasure conditions are set in the second codeword 320, 504 at all M symbol locations associated with a die for which errors were detected in the first codeword 318, 502, as described above in connection with FIGS. 3D, 3F, 3H, 5C, and 5D.

In a fifth aspect, alone or in combination with one or more of the first through fourth aspects, the one or more errors are associated with one or more data-pin locations of the memory system, and setting the one or more erasure conditions at the one or more symbol locations in the second codeword includes setting erasure conditions at all symbols in the second codeword that are associated with the one or more data-pin locations. For example, in some implementations an FCD scheme may use a DQ-based strategy in which erasure conditions are set in the second codeword 320, 504 at the same symbol and/or DQ positions for which errors were detected in the first codeword 318, 502, as described above in connection with FIGS. 3E, 3H, and 5B, and 5D.

In a sixth aspect, alone or in combination with one or more of the first through fifth aspects, the one or more errors are associated with a single memory device, of the multiple memory devices; when the one or more errors include a single symbol error, setting the one or more erasure conditions at the one or more symbol locations in the second codeword includes setting an erasure condition at a symbol location in the second codeword that corresponds to the symbol location of the single symbol error; and when the one or more symbol locations on the memory device are associated with multiple symbol errors, setting the one or more erasure conditions at the one or more symbol locations in the second codeword includes setting erasure conditions at all symbols in the second codeword that are associated with the single memory device. For example, in some implementations an FCD scheme (e.g., an FCD4 scheme) may use an optimized DQ-based strategy in which an erasure condition is set in the second codeword 320, 504 at a same symbol position for which an error was detected in the first codeword 318, 502 when only one error is detected, and in which erasure conditions are set in the second codeword 320, 504 at all M symbol locations associated with a die for which errors were detected in the first codeword 318, 502, as described above in connection with FIGS. 3H and 5D.

In a seventh aspect, alone or in combination with one or more of the first through sixth aspects, the method 600 includes receiving, from at least one memory device of the multiple memory devices, information associated with an OD-SEC component, and allocating, by the memory system controller, bit locations of the data block to the first codeword and to the second codeword based on the information associated with the OD-SEC component. For example, based on an OD-SEC implementation, bit locations of a data block may be allocated to the two codewords 318, 320, 502, 504 of an FCD scheme in such a way as to prevent likely errors from occurring only in the second codeword 320, 504, as described above in connection with FIG. 4A.

In an eighth aspect, alone or in combination with one or more of the first through seventh aspects, the method 600 includes receiving, from at least one memory device of the multiple memory devices, information associated with an OD-SEC component, wherein setting the one or more erasure conditions at the one or more symbol locations in the second codeword includes setting the one or more erasure conditions at the one or more symbol locations in the second codeword based on the information associated with the OD-SEC component. For example, an erasure condition may be set in the second codeword 320, 504 when an error is detected in a certain prefetch by the OD-SEC component, as described above in connection with FIGS. 4B-4C.

In a ninth aspect, alone or in combination with one or more of the first through eighth aspects, the second codeword is associated with a CRC portion, and the method 600 further comprises detecting whether the second codeword includes one or more errors using information associated with the CRC portion. For example, as described above in connection with FIGS. 5A-5D, a data block may further include CRC information (e.g., six bits of CRC information), which may be used when decoding the second codeword 320, 504 to increase an error detection capability of the FCD scheme and thus reduce an SDC rate associated with the FCD scheme.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a memory system includes one or more components configured to: receive, from multiple memory devices associated with the memory system, a data block, wherein the data block is associated with: a first codeword associated with a first data portion and a first parity portion, and a second codeword associated with a second data portion, a second parity portion, and a metadata portion; detect one or more errors at one or more symbol locations in the first codeword; correct the one or more errors in the first codeword using information in the first codeword; set one or more erasure conditions at one or more symbol locations in the second codeword, wherein the one or more symbol locations in the second codeword share a positional relationship with the one or more symbol locations in the first codeword having the one or more errors; and correct the one or more erasure conditions at the one or more symbol locations in the second codeword using information in the second codeword.

In some implementations, a system includes a memory system including multiple memory devices; and a host system in communication with the memory system, wherein the host system includes one or more components configured to: receive, from the memory system, a data block, wherein the data block is associated with: a first codeword associated with a first data portion and a first parity portion, and a second codeword associated with a second data portion, a second parity portion, and a metadata portion; detect one or more errors at one or more symbol locations in the first codeword; correct the one or more errors in the first codeword using information in the first codeword; set one or more erasure conditions at one or more symbol locations in the second codeword, wherein the one or more symbol locations in the second codeword share a positional relationship with the one or more symbol locations in the first codeword having the one or more errors; and correct the one or more erasure conditions at the one or more symbol locations in the second codeword using information in the second codeword.

In some implementations, a method includes receiving, by a memory system controller from multiple memory devices associated with the memory system controller, a data block, wherein the data block is associated with: a first codeword associated with a first data portion and a first parity portion, and a second codeword associated with a second data portion, a second parity portion, and a metadata portion; detecting, by the memory system controller, one or more errors at one or more symbol locations in the first codeword; correcting, by the memory system controller, the one or more errors in the first codeword using information in the first codeword; setting, by the memory system controller, one or more erasure conditions at one or more symbol locations in the second codeword, wherein the one or more symbol locations in the second codeword share a positional relationship with the one or more symbol locations in the first codeword having the one or more errors; and correcting, by the memory system controller, the one or more erasure conditions at the one or more symbol locations in the second codeword using information in the second codeword.

In some implementations, a method includes receiving, by a host system from a memory system associated with multiple memory devices, a data block, wherein the data block is associated with: a first codeword associated with a first data portion and a first parity portion, and a second codeword associated with a second data portion, a second parity portion, and a metadata portion; detecting, by the host system, one or more errors at one or more symbol locations in the first codeword; correcting, by the host system, the one or more errors in the first codeword using information in the first codeword; setting, by the host system, one or more erasure conditions at one or more symbol locations in the second codeword, wherein the one or more symbol locations in the second codeword share a positional relationship with the one or more symbol locations in the first codeword having the one or more errors; and correcting, by the host system, the one or more erasure conditions at the one or more symbol locations in the second codeword using information in the second codeword.

In some implementations, a compute express link (CXL) compliant memory system includes one or more components configured to: receive, from multiple dynamic random access memory (DRAM) dies associated with the CXL compliant memory system, a data block, wherein the data block is associated with: a first codeword associated with a first data portion and a first parity portion, and a second codeword associated with a second data portion, a second parity portion, and a metadata portion; detect one or more errors at one or more symbol locations in the first codeword; correct the one or more errors in the first codeword using information in the first codeword; set one or more erasure conditions at one or more symbol locations in the second codeword, wherein the one or more symbol locations in the second codeword share a positional relationship with the one or more symbol locations in the first codeword having the one or more errors; and correct the one or more erasure conditions at the one or more symbol locations in the second codeword using information in the second codeword.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more components configured to:
receive, from multiple memory devices associated with the memory system, a data block, wherein the data block is associated with:
a first codeword associated with a first data portion and a first parity portion, and
a second codeword associated with a second data portion, a second parity portion, and a metadata portion;
detect one or more errors at one or more symbol locations in the first codeword;
correct the one or more errors in the first codeword using information in the first codeword;
set one or more erasure conditions at one or more symbol locations in the second codeword, wherein the one or more symbol locations in the second codeword share a positional relationship with the one or more symbol locations in the first codeword having the one or more errors; and
correct the one or more erasure conditions at the one or more symbol locations in the second codeword using information in the second codeword.

2. The memory system of claim 1, wherein a quantity of bits per symbol associated with the first codeword differs from a quantity of bits per symbol associated with the second codeword.

3. The memory system of claim 1, wherein the first codeword and the second codeword are associated with a same total quantity of symbols, and
wherein the total quantity of symbols divided by a quantity of the multiple memory devices is equal to one of 1, 2, or 4.

4. The memory system of claim 3, wherein, when the total quantity of symbols divided by the quantity of the multiple memory devices is equal to 1, the first codeword and the second codeword are associated with one of Reed-Solomon codes or non-binary Hamming codes, and
wherein, when the total quantity of symbols divided by the quantity of the multiple memory devices is equal to one of 2 or 4, the first codeword and the second codeword are associated with Reed-Solomon codes.

5. The memory system of claim 1, wherein the one or more errors are associated with a single memory device, of the multiple memory devices, and
wherein the one or more components, to set the one or more erasure conditions at the one or more symbol locations in the second codeword, are configured to set erasure conditions at all symbols in the second codeword that are associated with the single memory device.

6. The memory system of claim 1, wherein the one or more errors are associated with one or more data-pin locations of the memory system, and
wherein the one or more components, to set the one or more erasure conditions at the one or more symbol locations in the second codeword, are configured to set erasure conditions at all symbols in the second codeword that are associated with the one or more data-pin locations.

7. The memory system of claim 1, wherein the one or more errors are associated with a single memory device, of the multiple memory devices,
wherein, when the one or more errors include a single symbol error, the one or more components, to set the one or more erasure conditions at the one or more symbol locations in the second codeword, are configured to set an erasure condition at a symbol location in the second codeword that corresponds to the symbol location of the single symbol error, and
wherein, when the one or more symbol locations on the memory device are associated with multiple symbol errors, the one or more components, to set the one or more erasure conditions at the one or more symbol locations in the second codeword, are configured to set erasure conditions at all symbols in the second codeword that are associated with the single memory device.

8. The memory system of claim 1, wherein the one or more components are further configured to:
receive, from at least one memory device of the multiple memory devices, information associated with an on-die single error correction (OD-SEC) component, and
allocate bit locations of the data block to the first codeword and to the second codeword based on the information associated with the OD-SEC component.

9. The memory system of claim 1, wherein the one or more components are further configured to receive, from at least one memory device of the multiple memory devices, information associated with an on-die single error correction (OD-SEC) component, and
wherein the one or more components, to set the one or more erasure conditions at the one or more symbol locations in the second codeword, are further configured to set the one or more erasure conditions at the one or more symbol locations in the second codeword based on the information associated with the OD-SEC component.

10. The memory system of claim 1, wherein the second codeword is associated with a cyclic redundancy check (CRC) portion, and
wherein the one or more components are further configured to detect whether the second codeword includes one or more errors using information associated with the CRC portion.

11. A system, comprising:
a memory system including multiple memory devices; and
a host system in communication with the memory system, wherein the host system includes one or more components configured to:
receive, from the memory system, a data block, wherein the data block is associated with:
a first codeword associated with a first data portion and a first parity portion, and
a second codeword associated with a second data portion, a second parity portion, and a metadata portion;
detect one or more errors at one or more symbol locations in the first codeword;
correct the one or more errors in the first codeword using information in the first codeword;
set one or more erasure conditions at one or more symbol locations in the second codeword, wherein the one or more symbol locations in the second codeword share a positional relationship with the one or more symbol locations in the first codeword having the one or more errors; and
correct the one or more erasure conditions at the one or more symbol locations in the second codeword using information in the second codeword.

12. The system of claim 11, wherein a quantity of bits per symbol associated with the first codeword differs from a quantity of bits per symbol associated with the second codeword.

13. The system of claim 11, wherein the first codeword and the second codeword are associated with a same total quantity of symbols, and
wherein the total quantity of symbols divided by a quantity of the multiple memory devices is equal to one of 1, 2, or 4.

14. The system of claim 13, wherein, when the total quantity of symbols divided by the quantity of the multiple memory devices is equal to 1, the first codeword and the second codeword are associated with one of Reed-Solomon codes or non-binary Hamming codes, and
wherein, when the total quantity of symbols divided by the quantity of the multiple memory devices is equal to one of 2 or 4, the first codeword and the second codeword are associated with Reed-Solomon codes.

15. The system of claim 11, wherein the one or more errors are associated with a single memory device, of the multiple memory devices, and
wherein the one or more components, to set the one or more erasure conditions at the one or more symbol locations in the second codeword, are configured to set erasure conditions at all symbols in the second codeword that are associated with the single memory device.

16. The system of claim 11, wherein the one or more errors are associated with one or more data-pin locations of the memory system, and
wherein the one or more components, to set the one or more erasure conditions at the one or more symbol locations in the second codeword, are configured to set erasure conditions at all symbols in the second codeword that are associated with the one or more data-pin locations.

17. The system of claim 11, wherein the one or more errors are associated with a single memory device, of the multiple memory devices,
wherein, when the one or more errors include a single symbol error, the one or more components, to set the one or more erasure conditions at the one or more symbol locations in the second codeword, are configured to set an erasure condition at a symbol location in the second codeword that corresponds to the symbol location of the single symbol error, and
wherein, when the one or more symbol locations on the memory device are associated with multiple symbol errors, the one or more components, to set the one or more erasure conditions at the one or more symbol locations in the second codeword, are configured to set erasure conditions at all symbols in the second codeword that are associated with the single memory device.

18. The system of claim 11, wherein the one or more components are further configured to:
receive, from at least one memory device of the multiple memory devices, information associated with an on-die single error correction (OD-SEC) component, and
allocate bit locations of the data block to the first codeword and to the second codeword based on the information associated with the OD-SEC component.

19. The system of claim 11, wherein the one or more components are further configured to receive, from at least one memory device of the multiple memory devices, information associated with an on-die single error correction (OD-SEC) component, and
wherein the one or more components, to set the one or more erasure conditions at the one or more symbol locations in the second codeword, are further configured to set the one or more erasure conditions at the one or more symbol locations in the second codeword based on the information associated with the OD-SEC component.

20. The system of claim 11, wherein the second codeword is associated with a cyclic redundancy check (CRC) portion, and
wherein the one or more components are further configured to detect whether the second codeword includes one or more errors using information associated with the CRC portion.

21. A method, comprising:
receiving, by a memory system controller from multiple memory devices associated with the memory system controller, a data block, wherein the data block is associated with:
a first codeword associated with a first data portion and a first parity portion, and
a second codeword associated with a second data portion, a second parity portion, and a metadata portion;
detecting, by the memory system controller, one or more errors at one or more symbol locations in the first codeword;
correcting, by the memory system controller, the one or more errors in the first codeword using information in the first codeword;
setting, by the memory system controller, one or more erasure conditions at one or more symbol locations in the second codeword, wherein the one or more symbol locations in the second codeword share a positional relationship with the one or more symbol locations in the first codeword having the one or more errors; and
correcting, by the memory system controller, the one or more erasure conditions at the one or more symbol locations in the second codeword using information in the second codeword.

22. The method of claim 21, wherein the one or more errors are associated with a single memory device, of the multiple memory devices, and wherein setting the one or more erasure conditions at the one or more symbol locations
in the second codeword includes setting erasure conditions at all symbols in the second codeword that are associated with the single memory device.

23. The method of claim 21, wherein the one or more errors are associated with one or more data-pin locations of the memory system, and
wherein setting the one or more erasure conditions at the one or more symbol locations in the second codeword includes setting erasure conditions at all symbols in the second codeword that are associated with the one or more data-pin locations.

24. The method of claim 21, wherein the one or more errors are associated with a single memory device, of the multiple memory devices,
wherein, when the one or more errors include a single symbol error, setting the one or more erasure conditions at the one or more symbol locations in the second codeword includes setting an erasure condition at a symbol location in the second codeword that corresponds to the symbol location of the single symbol error, and
wherein, when the one or more symbol locations on the memory device are associated with multiple symbol errors, setting the one or more erasure conditions at the one or more symbol locations in the second codeword includes setting erasure conditions at all symbols in the second codeword that are associated with the single memory device.

25. The method of claim 21, further comprising:
receiving, by the memory system controller from at least one memory device of the multiple memory devices, information associated with an on-die single error correction (OD-SEC) component, and
allocating, by the memory system controller, bit locations of the data block to the first codeword and to the second codeword based on the information associated with the OD-SEC component.

26. The method of claim 21, further comprising receiving, by the memory system controller from at least one memory device of the multiple memory devices, information associated with an on-die single error correction (OD-SEC) component,
wherein setting the one or more erasure conditions at the one or more symbol locations in the second codeword includes setting the one or more erasure conditions at the one or more symbol locations in the second codeword based on the information associated with the OD-SEC component.

27. The method of claim 21, wherein the second codeword is associated with a cyclic redundancy check (CRC) portion, and
wherein the method further comprises detecting, by the memory system controller, whether the second codeword includes one or more errors using information associated with the CRC portion.

28. A method, comprising:
receiving, by a host system from a memory system associated with multiple memory devices, a data block, wherein the data block is associated with:
a first codeword associated with a first data portion and a first parity portion, and
a second codeword associated with a second data portion, a second parity portion, and a metadata portion;
detecting, by the host system, one or more errors at one or more symbol locations in the first codeword;
correcting, by the host system, the one or more errors in the first codeword using information in the first codeword;
setting, by the host system, one or more erasure conditions at one or more symbol locations in the second codeword, wherein the one or more symbol locations in the second codeword share a positional relationship with the one or more symbol locations in the first codeword having the one or more errors; and
correcting, by the host system, the one or more erasure conditions at the one or more symbol locations in the second codeword using information in the second codeword.

29. The method of claim 28, wherein the one or more errors are associated with a single memory device, of the multiple memory devices, and
wherein setting the one or more erasure conditions at the one or more symbol locations in the second codeword includes setting erasure conditions at all symbols in the second codeword that are associated with the single memory device.

30. The method of claim 28, wherein the one or more errors are associated with one or more data-pin locations of the memory system, and
wherein setting the one or more erasure conditions at the one or more symbol locations in the second codeword includes setting erasure conditions at all symbols in the second codeword that are associated with the one or more data-pin locations.

31. The method of claim 28, wherein the one or more errors are associated with a single memory device, of the multiple memory devices,
wherein, when the one or more errors include a single symbol error, setting the one or more erasure conditions at the one or more symbol locations in the second codeword includes setting an erasure condition at a symbol location in the second codeword that corresponds to the symbol location of the single symbol error, and
wherein, when the one or more symbol locations on the memory device are associated with multiple symbol errors, setting the one or more erasure conditions at the one or more symbol locations in the second codeword includes setting erasure conditions at all symbols in the second codeword that are associated with the single memory device.

32. A compute express link (CXL) compliant memory system, comprising:
one or more components configured to:
receive, from multiple dynamic random access memory (DRAM) dies associated with the CXL compliant memory system, a data block, wherein the data block is associated with:
a first codeword associated with a first data portion and a first parity portion, and
a second codeword associated with a second data portion, a second parity portion, and a metadata portion;
detect one or more errors at one or more symbol locations in the first codeword;
correct the one or more errors in the first codeword using information in the first codeword;
set one or more erasure conditions at one or more symbol locations in the second codeword, wherein the one or more symbol locations in the second codeword share a positional relationship with the one or more symbol locations in the first codeword having the one or more errors; and
correct the one or more erasure conditions at the one or more symbol locations in the second codeword using information in the second codeword.

33. The CXL compliant memory system of claim 32, wherein the one or more components are further configured to:
receive, from at least one DRAM die of the multiple DRAM dies, information associated with an on-die single error correction (OD-SEC) component, and
allocate bit locations of the data block to the first codeword and to the second codeword based on the information associated with the OD-SEC component.

34. The CXL compliant memory system of claim 32, wherein the one or more components are further configured to receive, from at least one DRAM die of the multiple DRAM dies, information associated with an on-die single error correction (OD-SEC) component, and
wherein the one or more components, to set the one or more erasure conditions at the one or more symbol locations in the second codeword, are further configured to set the one or more erasure conditions at the one or more symbol locations in the second codeword based on the information associated with the OD-SEC component.

35. The CXL compliant memory system of claim 32, wherein the second codeword is associated with a cyclic redundancy check (CRC) portion, and
wherein the one or more components are further configured to detect whether the second codeword includes one or more errors using information associated with the CRC portion.
